(19) United States
(12) Patent Application Publication
(10) Pub. No.: US 2002/0073122 A1
(43) Pub. Date: Jun. 13, 2002

(54) Display apparatus, and computer-readable recording medium in which display control program is recorded

(75) Inventors: Satoshi Iwata, Kawasaki (JP); Shoji Suzuki, Kawasaki (JP)

Correspondence Address: STAAS & HALSEY LLP, 700 11TH STREET, NW, SUITE 500, WASHINGTON, DC, 20001, US

(73) Assignee: FUJITSU LIMITED, Kawasaki (JP)

(21) Appl. No.: 09/862,448

(22) Filed: May 23, 2001

(30) Foreign Application Priority Data
Dec. 12, 2000 (JP) 2000-377819

(51) Int. Cl. G06F 15/00

(52) U.S. Cl. 707/525; 707/517

(57) ABSTRACT

The present invention relates to an apparatus capable of, in reading document contents on a monitor screen, conducting paging in a state where the contents of each page are surely seizable and of shortening the waiting time for display switching between pages. Accordingly, the apparatus has a function to fulfill a display mode of displaying the whole contents of each page and plural display modes of conducting paging at different speeds and successively displaying partially or schematically the contents of each page according to a display method corresponding to each of the different speeds. A display control section displays the document contents on the displaying section in the display mode selected by a selecting section. The apparatus according to the present invention is applicable to paging to be conducted in searching a reading place while turning pages of magazines, newspapers, manuals or the like on a monitor screen.

### BACKGROUND OF THE INVENTION

1) Field of the Invention

The present invention relates to a display apparatus made to display electronic book-form contents (document contents made up in units of page) on a monitor screen and a computer-readable recording medium retaining a display control program for controlling a display condition of each of pages on the monitor screen, and more particularly to a technique suitable, for example, for use in turning the pages for looking for a reading place while seeing information on the pages of magazines, newspapers, manuals, or the like on the monitor screen.

2) Description of the Related Art

In the recent years, electronic book-form contents (business documents, magazines, books, newspapers, and others) made up in units of one page have been in progress. Such book-form contents are read in the form of hard copy, alternatively, they are read in a state displayed on a monitor screen 1a of a portable display apparatus [PDA (Personal Digital Assistant)] 1 shown in FIG. 24A or displayed on a monitor screen 2a of a PC (Personal Computer) 2 shown in FIG. 24B. The former reading is not a good policy from the viewpoint of resource protection because of use of paper, whereas the latter that uses electronic data appearing on the monitor screen 1a or 2a in the form of electronic display is preferable in this respect.

Among document contents (book-form contents), when roughly classified, there are books, magazines, business documents, manuals, and others. For reading these contents, a reader naturally wishes to quickly find a target or desired place he/she wants to read. For example, except for reading books, such as novels that one theme spans the whole contents, all at once, readers almost always look for a necessary place of the contents, before reading that place. In particular, when reading a magazine or manual, in most cases, the readers seizes the contents at random.

For this reason, in reading document contents displayed on a monitor screen, for example, shown in FIG. 25B, there is a need for a page displaying technique capable of reaching a target place (page) of the document contents faster for reading that place.

FIGS. 25A and 25B are illustrations of examples of common document contents. Of these illustrations, FIG. 25A is an illustration of a format of layout information on each page, which is preserved at every page of the document contents, and FIG. 25B is an illustration of an example of a page image to be displayed actually on the basis of the layout information shown in FIG. 25A.

In a case in which a page image includes an area for displaying three types of character data A, B and C and an area for displaying two types of image data a and b as shown in FIG. 25B, in addition to document constituting information, these character data A, B, C and image data a, bare included as layout information.

In this case, the document constituting information includes composition information, ID (Identification Information) of each element, positional information on each element and appearance information. In addition, each character data includes font sizes, font types, character colors, character spaces, and others, while each image data includes image file types, image sizes and others. The element of the document-constituting information signifies each character data or each image data.

Meanwhile, as techniques to be taken for when a reader looks for a target page in electronic document contents, for example, there are (1) use of contents, (2) retrieval based on a key word, (3) scrolling, and (4) glancing.

In the case of the technique (1) (use of contents), the corresponding page is previously linked up with each of the items written initially in document contents, and a desired item is selected from the contents displayed on a monitor screen, thereby moving to a page corresponding to the selected item.

In the case of the technique (2) (retrieval based on a key word), text information on document contents is retrieved on the basis of a key word related to the target information, and a reading place or a page is selected from pages indicated in the retrieval result.

In the case of the technique (3) (scrolling), for example, as shown in FIG. 26, a software key (scroll bar) operable through a mouse or the like is displayed in a portion (lower portion in FIG. 26) of a viewer for displaying pages (information on pages), and a page to be displayed is made to be determined as a function of a manipulated variable of the key (or the position of the key) so that the image of the determined page is displayed.

In the case of the technique (4) (glancing), the pages of the document contents are successively displayed at a constant speed, and a reader refers to the pages displayed successively in this way, thereby looking for a desired information displaying page.

The aforesaid techniques (1) and (2) relate to conventional book handling ways applied to electronic document contents. These ways are taken in a case in which item names or key words are recognized previously as information useful for looking for a reading place. Concretely, they are frequently put to use in making retrieval on reference books such as manuals and dictionaries.

On the other hand, in the case of document contents such as magazines and newspapers, looking for a reading place, readers commonly see a general view of the written contents while successively turning the pages of the document contents. For example, the readers refer to information such as title, headline, image, graph or layout while turning or ejecting pages (paging), thereby retrieving a reading place. The foregoing techniques (3) and (4) are available in this case.

For example, Japanese Patent Laid-Open Publication No. HEI 11-175549 discloses a technique in which a continuous page ejection time (paging time) is detected in conducting a fast page ejection (fast paging) according to the technique (4) to alter the display contents (display method) in accordance with the detected paging time for easy confirmation on each page.

Meanwhile, a reader, who intends to see, for example, a magazine, newspaper or the like on a monitor screen, when seeking for a reading place while paging successively, turns pages toward a target place (page) while judging, through visual observation, as to whether or not each page includes contents to be read.

Accordingly, in the paging for looking for a reading place in document contents, in the first place, there is a need to provide, to a reader, information on each page useful for making a decision on whether or not it is a place the reader wants to read, and in the second place, there is a need to avoid spending an additional waiting time in displaying that information on a monitor screen at every page.

In the case of using the aforesaid technique (3) (scrolling), however, if the number of pages of document contents undergoing reading/retrieval is large, even a slight key operation causes considerable page jumping on the monitor screen, which makes it difficult to seize the general view or contents of each page through visual observation. This requires the reader to manipulate a scroll key before and after by trial and error for reaching a desired page.

In addition, in the case of the aforesaid technique (4) (glancing), the processing for displaying the entire page image at every page takes time so that a reader is required to wait for the completion of display for each page, thus causing an additional waiting time. For saving such an additional waiting time, a fast image-rewritable (reloadable) hardware becomes necessary, which increases cost accordingly. On the other hand, conceivably, for saving the aforesaid additional waiting time in a state where the hardware does not operate at a sufficient processing speed, display/rewrite to the next page is conducted at the time of the elapse of a given period of time without waiting for the completion of the display/rewrite of the entire image of each page. However, in this case, since the display for each page stops halfway, the reader cannot make a satisfactory decision on whether or not that page shows the reading place.

Furthermore, according to the technique disclosed in Japanese Patent Laid-Open Publication No. HEI 11-175549, since the paging speed is constant, difficulty is encountered in combining page ejection (paging) for going through pages and paging for confirming or scanning the contents to look for a reading place. In addition, although a change of display on a monitor screen takes place stepwise according to page as a function of the time needed for continuous paging, the contents to be displayed in each displaying mode are page numbers, the types and volumes of information introduced for each page, the present page position, and other information; therefore, the reader cannot seize the general view or contents of each page from such display contents through visual observation. Still additionally, since each page displaying mode is changed in accordance with the continuous paging time regardless of the intention of a reader, it is difficult to make a page display the reader desires.

### SUMMARY OF THE INVENTION

The present invention has been developed with a view to eliminating these problems, and it is therefore an object of the invention to realize a high-operability page turning function capable of, in reading document contents on a monitor screen, conducting page ejection (paging) in a state securing a sure understanding of the contents of each page and of shortening the waiting time stemming from display switching between pages, thus easily, quickly and surely achieving reaching to a target page and providing the sensation closer to the real books.

For this purpose, in accordance with the present invention, there is provided a display apparatus comprising a displaying section for displaying document contents made up in units of page, a displaying control section for controlling a display state of the displaying section, means for providing a reading display mode of displaying the whole of each page of the document contents on a displaying section, means for providing a plurality of automatic paging display modes of conducting page ejection (paging) at different speeds and successively displaying partially or schematically the contents of each page of the document contents on the displaying section according to a display method corresponding to each of the different speeds, and selecting means for selecting one of the reading display mode and the plurality of automatic paging display modes, with the display control section controlling the display state of the displaying section to display the document contents on the displaying section in the display mode selected by the selecting means.

Furthermore, in accordance with the present invention, there is provided a computer-readable recording medium for realizing the aforesaid display apparatus and for recording a display control program to display document contents, made up in units of page, on a displaying section, the display control program making a computer function as means for providing a reading display mode of displaying the whole of each page of the document contents on a displaying section, means for providing a plurality of automatic paging display modes of conducting page ejection (paging) at different speeds and successively displaying partially or schematically the contents of each page of the document contents on the displaying section according to a display method corresponding to each of the different speeds, and a display control section to control a display state in the displaying section for displaying the document contents on the displaying section in a display mode selected from the reading display mode and the plurality of automatic paging display modes.

At this time, it is also appropriate that the plurality of automatic paging display modes includes at least two modes of a cursory reading (skimming) display mode of making display so that the outline of the contents of each page is seizable to a reader and a general view display mode of conducting page ejection (paging) at a speed higher than that of the cursory reading display mode to make display so that the whole of each page is generally viewable to the reader. It is also acceptable that the cursory reading display mode makes a title-display of extracting and displaying only a title of each page, while the general view display mode makes a layout-display of illustratively displaying a layout in each page.

With the foregoing arrangement according to the present invention, when a reader carefully reads a specified page, the reader selects the reading display mode so that the whole of that page fixedly appears on the displaying section. On the other hand, for conducting page ejection (paging) while seizing the contents of each page, the reader selects one of the plurality of automatic paging display modes, in which case the respective pages are partially or schematically displayed successively at a desired speed and according to a displaying method corresponding to that speed.

This shortens the waiting time stemming from display switching between pages, attendant upon the paging, and without spending an additional waiting time, conducts the paging display while instantaneously giving, to the reader, information useful for judging whether or not that page contains the target place.

In addition, this enables the selection and change of the paging speed and accomplishes the display of the contents of each page according to a display method corresponding to the selected paging speed, which enables the paging in a state where the contents of each page are surely seizable and the paging for going through pages and the paging for the conformation of the contents to look for a reading place to be compatible with each other.

At this time, in the cursory reading display mode forming one of the automatic paging display modes, for example, only the title of each page is displayed, in which case the reader can cursorily read the contents while seizing the outline of the contents of each page. In addition, in the general view display mode forming the other automatic paging display mode, the pages are turned at a speed higher than that of the cursory reading display mode and, for example, the layout in each page is displayed illustratively, so the reader can generally view the whole of each page. That is, this enables three-way page display [careful reading, cursory reading (skimming), general view (glancing)] to a reading/searching behavior to be done for when a human being actually reads documents such as magazines and newspapers.

Thus, the display apparatus and computer-readable recording medium according to the present invention can provide the following effects and advantages.

(1) The paging can be conducted in a state where the contents of each page are seizable to a reader, thus surely preventing passing by a desired page, and it is possible to shorten the waiting time stemming from the display switching between pages, so the reader can easily and surely reach an aiming page.

(2) A display apparatus (electronic document contents display) is realizable which can conduct a page display to reading/searching behavior for when a human being reads documents actually and which has a high-operability page turning function providing a sensation closer to the real books.

(3) In the automatic paging display mode, when some are extracted from document components, constituting each page, according to a predetermined condition (for example, a font size or font type) and displayed to make a partial display of each page (the contents of each page), it is possible to conduct the paging while displaying only a title portion or emphasized portion of the document contents.

(4) In the automatic paging display mode, only an image is extracted from each page and displayed to make a partial display of each page, thus displaying only an image portion which is instantaneously and easily seizable at the paging.

(5) In the automatic paging display mode, the display resolution of each page is altered as a function of the paging speed (the display resolution becomes lower as the speed increases), so it is possible to schematically display the contents of each page and to display only the document structure at the paging.

(6) Since the display method and the paging speed can be set in each of the automatic paging display modes, it is possible to handle various types of document contents, and further to conduct the page ejection (paging) according to a display method or at a speed the reader wants in using the display apparatus (electronic document contents display).

(7) It is possible to automatically perform the switching among the automatic paging display modes in a manner that the automatic paging display mode is determined on the basis of the time of manipulation of a paging switch.

(8) It is possible to arbitrarily switch the automatic paging display mode according to the intention of the reader in a manner that the automatic paging display mode is determined in accordance with a method of manipulating a plurality of paging switches.

### BRIEF DESCRIPTION OF THE DRAWINGS

FIG. 1 is a block diagram showing a configuration of a display apparatus (electronic document contents display) according to an embodiment of the present invention;

FIGS. 2A to 2C are illustrations useful for explaining a speed at which a human being reads documents;

FIG. 3 is a flow chart useful for explaining a first example of display processing in the display apparatus according to this embodiment;

FIG. 4 is an illustration of establishment contents (establishment table) of display modes in the first example of display processing;

FIG. 5 is a flow chart useful for explaining a second example of display processing in the display apparatus according to this embodiment;

FIG. 6A is an illustration of an establishment example of a display mode switching reference (pressing time of a paging switch) in the second example of display processing;

FIG. 6B is an illustration of establishment contents (establishment table) of display modes in the second example of display processing;

FIG. 7 is an illustration useful for explaining a first modification (a first example of a method for selecting a display mode using a plurality of paging switches) of a display mode selecting method in the second example of display processing;

FIG. 8 is an illustration of an establishment example of a display mode switching reference (a method of manipulating the paging switches) in the first modification of the display mode selecting method;

FIG. 9 is an illustration useful for explaining a second modification (a second example of a method for selecting a display mode using a plurality of paging switches) of the display mode selecting method in the second example of display processing;

FIG. 10 is an illustration of an establishment example of a display mode switching reference (a method of manipulating the paging switches) in the second modification of the display mode selecting method;

FIG. 11 is a flow chart useful for explaining a third example of display processing in the display apparatus according to this embodiment;

FIG. 12 is an illustration of establishment contents (establishment table) of display modes in the third example of display processing in the display apparatus;

FIG. 13 is an illustration of establishment contents (establishment table) of display modes in a fourth example of display processing in the display apparatus according to this embodiment;

FIG. 14 is an illustration of a concrete display example of display modes in the fourth example of display processing;

FIG. 15 is a flow chart useful for explaining a fifth example of display processing in the display apparatus according to this embodiment;

FIG. 16 is an illustration of establishment contents (establishment table) of display modes in the fifth example of display processing;

FIG. 17 is a flow chart useful for explaining a sixth example of display processing in the display apparatus according to this embodiment;

FIG. 18 is an illustration of establishment contents (establishment table) of display modes in the sixth example of display processing;

FIG. 19 is a flow chart useful for explaining a seventh example of display processing in the display apparatus according to this embodiment;

FIG. 20 is an illustration of establishment contents (establishment table) of display modes in the seventh example of display processing;

FIG. 21 is a flow chart useful for explaining an eighth example of display processing in the display apparatus according to this embodiment;

FIG. 22 is an illustration of establishment contents (establishment table) of display modes in the eighth example of display processing;

FIG. 23A is an illustration of individual establishment example (establishment table) of display modes, set by a setting means of the display apparatus according to this embodiment;

FIG. 23B is an illustration useful for explaining a display method which can be established by the setting means;

FIGS. 24A and 24B are perspective views each illustratively showing a portable display and a PC, employed as a display apparatus for displaying book-form contents;

FIGS. 25A and 25B are illustrations of an example of common document contents, and of these illustrations, FIG. 25A is an illustration of a layout information format for each page, preserved at every page of the document contents and FIG. 25B is an illustration of an example of a page image to be displayed actually on the basis of the layout information of FIG. 25A; and

FIG. 26 is an illustration for describing a common page searching method using a scroll bar.

### DESCRIPTION OF THE PREFERRED EMBODIMENTS

An embodiment of the present invention will be described hereinbelow with reference to the drawings.

(1) Description of Principle of the Invention

In an embodiment of the present invention, each paging speed on a monitor screen and a display element (display method) of document contents to be displayed on the monitor screen are selected and set in conjunction with a reading behavior to be done unconsciously for when human beings read books actually.

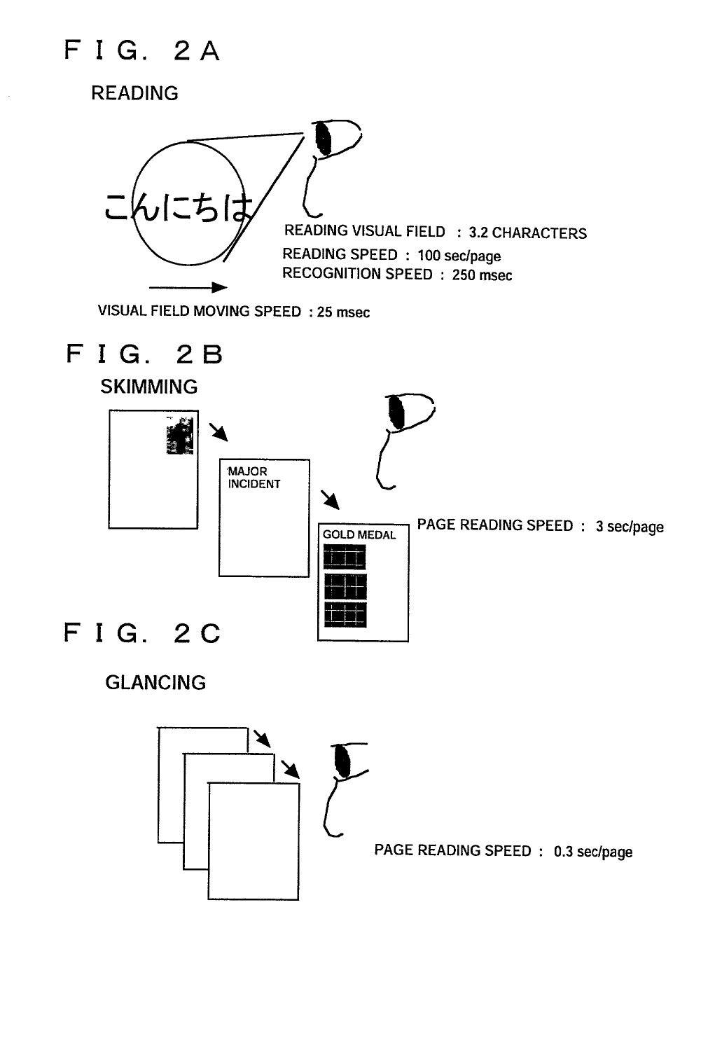

Thus, referring first to FIGS. 2A to 2C, a description will be given hereinbelow of a human document reading speed.

When reading document contents made up in units of page, human beings take at least the following three types of reading behaviors (i) to (iii).

(i) Reading: Behavior done for when human beings commonly read the whole document contents (careful reading).

Naturally, when taking the common reading behavior, a reader reads a document (characters) while following with his/her eyes. When Japanese language is read in this way, for example, as FIG. 2A shows, the characters covered with a range (reading visual field) of one observing point are approximately 3.2 in number, and the time (recognition speed, stay time at observing point) to be taken for understanding/recognizing the 3.2 characters within that range is approximately 250 msec (milliseconds) on the average. In addition, the time (shift time between reading visual fields) to be taken for shifting the present 3.2 characters to the next 3.2 characters is approximately 25 msec. Thus, the average number of characters per page is 1200 (B5 size) to 2600 (A4 size), and the time (reading speed) needed for reading the characters (Japanese) corresponding to one page reaches 100 to 200 seconds. Incidentally, each of the B5 size and the A4 size signifies finished dimension of a paper sheet according to the Japan Industry Standard.

(ii) Skimming: Behavior done for when human beings seize the contents of each page by seeing only the title, headline, image or graph of document contents (cursory reading).

In this behavior, for example, as FIG. 2B shows, an understanding of the outline of each page depends upon reading a headline or seeing a picture and each page is read while making a decision on adoption/rpaging of each page. For example, if an information magazine is taken as the document contents, without seeing the whole page, a reader sees only the information (for example, store name) noticeable and necessary to the reader. If four headlines each having approximately ten entries are present on one page, the reading time per page becomes approximately three seconds in the case of the aforesaid skimming.

(iii) Glancing: Behavior done for when human beings generally view the whole contents of each page without seizing the substance of the document contents.

The contents are generally viewed while turning pages without understanding the meaning of a document. For example, as FIG. 2C shows, this general view behavior is taken for recognizing the location of a picture or for recognizing a layout configuration (column, main body, or the like). In the case of this general view behavior, the reading time per page, that is, the time to be taken for recognizing one pattern without shifting the observing point, is approximately 0.3 second.

In the display apparatus according to this embodiment, the paging operation is conducted at a speed based on the aforesaid reading time on a monitor screen and, at the same time, the element display (partial display of an element constituting document contents) is made in accordance with that speed, thereby realizing the paging capable of displaying information necessary for making a decision on whether or not the contents of each page includes a desired reading place, without producing an additional waiting time.

Accordingly, in the display apparatus according to this embodiment, in addition to a reading display mode (which will sometimes be referred to hereinafter as “sequential paging”) corresponding to the aforesaid careful reading, there are set a first automatic paging display mode (cursory reading display mode; which will sometimes be referred to hereinafter as “automatic paging 1”) and a second automatic paging display mode (general view display mode; which will sometimes be referred to as hereinafter as “automatic paging 2”) corresponding to the aforesaid skimming behavior and the aforesaid glancing, respectively.

The paging speeds (display times per page) for these three types of display modes are set in the following three states.

(a1) In the reading display mode (sequential paging), in accordance with a paging instruction from a reader, pages are turned, that is, the next page is displayed on a monitor screen. With no instruction from the reader, the present display picture continuously appears on the monitor screen.

(a2) In the first automatic paging display mode (automatic paging 1), pages are automatically turned at an interval of more than 1 second, for example, approximately 3 seconds, in accordance with a paging instruction from a reader.

(a3) In the second automatic paging display mode (automatic paging 2), pages are automatically turned at a short interval, for example, below 1 second in accordance with a paging instruction from a reader.

In addition, methods of displaying document components in the foregoing three types of display modes are set like the following (b1) to (b3).

(b1) In the reading display mode (sequential paging), the entire image (all sentences) on each page is directly displayed on a monitor screen.

(b2) In the first automatic paging display mode (automatic paging 1), each page is displayed on a monitor screen according to a display method (which will sometimes be referred to hereinafter as a “display method 1” or “partial display 1”) corresponding to the aforesaid skimming behavior. For example, displayed are only characters each having a font satisfying a predetermined condition (for example, characters above 12 points).

(b3) In the second automatic paging display mode (automatic paging 2), each page is displayed on a monitor screen according to a display method (which will sometimes be referred to hereinafter as a “display method 1” or “partial display 2”) corresponding to the aforesaid general view behavior. For example, displayed is only a layout configuration of each page.

With the above-mentioned display modes set in advance, when selecting the aforesaid second automatic paging display mode for successively conducting the paging by glancing at each page, a reader can conduct the automatic paging while displaying, for example, only the document layout on each page, thereby shortening the waiting time for page display.

Moreover, when a reader selects the aforesaid first automatic paging display mode for conducting the skimming of each page, the automatic paging is done while displaying, for example, only a title of each page, which makes it easy to make a decision on whether that page is worth reading or not.

Thus, according to this embodiment of the present invention, a reader can make a display, he/she wants, by selecting one display mode properly from a plurality of display modes respectively corresponding to reading behaviors done unconsciously for when human beings read books actually, which enables fast paging for merely turning pages and paging for search and confirmation of contents to be compatible with each other. In addition, this permits the display of document contents such as magazines according to a manner similar to a reading behavior and retrieving behavior human beings take actually.

(2) Description of Configuration of Display Apparatus According to the Embodiment

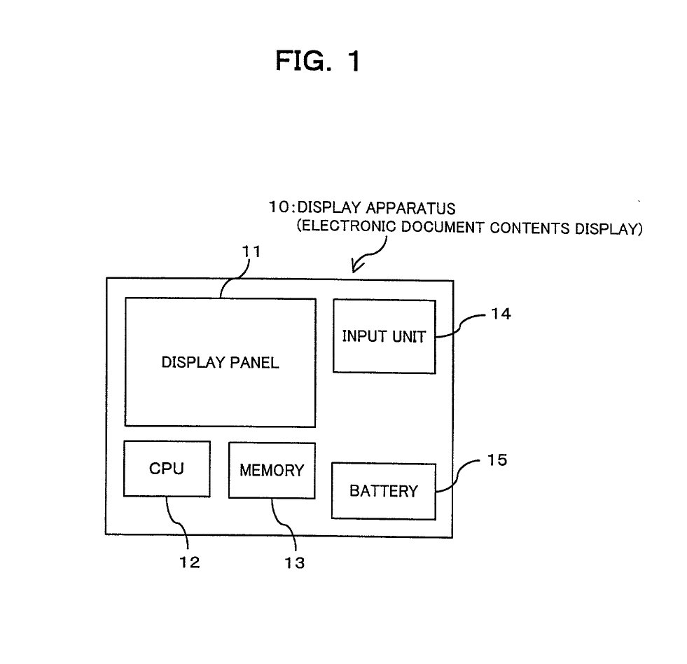

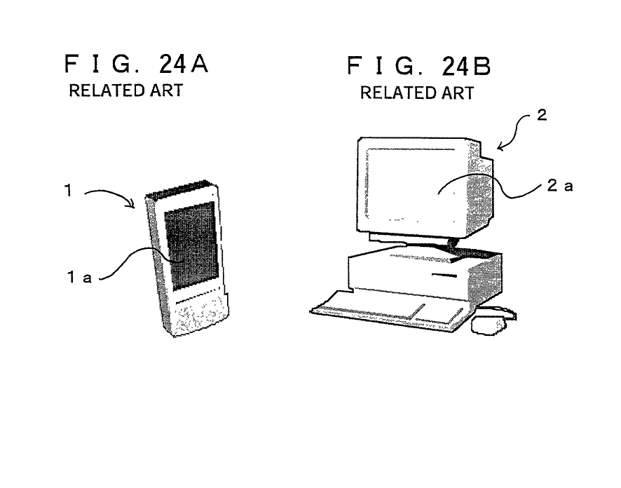

FIG. 1 is a block diagram showing a configuration of a display apparatus (electronic document contents display) according to an embodiment of the present invention. As FIG. 1 shows, a display apparatus 10 according to this embodiment is an electronic document contents display applied to, for example, a portable display (PDA) 1 equipped with a monitor screen 1a, which has been described above with reference to FIG. 24A, and is made up of a display panel 11, a CPU (Central Processing Unit; arithmetic processing unit) 12, a memory 13, an input unit 14, and a battery 15.

The display panel 11 is constructed with, an LCD (Liquid Crystal Display), a PDP (Plasma Display Panel), or the like, and is for displaying various information. In this embodiment, it functions as a displaying section to display each page of document contents (magazines, newspapers, manuals, and others) made up in units of page.

The CPU 12 is for implementing various kinds of arithmetic operations to wholly manage operations of the display apparatus 10, and the memory 13 is for storing various types of programs to be executed in the CPU 12 and various types of data such as document contents to be displayed on the display panel 11, and it further functions as a working area to be used for when the CPU 12 performs the various kinds of arithmetic operations.

The input unit 14 is operated by a reader for inputting, for example, various kinds of instructions such as display mode selecting instructions or various types of data such as display mode establishment data, and it functions as a selecting means or establishing (setting) means which will be described herein later. Concretely, this input unit 14 is constructed in the form of hardware keys placed on the display apparatus 10 or software keys displayed on the display panel 11.

The battery 15 is for supplying power necessary for operations of the display apparatus 10.

Furthermore, in this embodiment, the memory 13 retains a display control program which makes the CPU 12 function as a display control section to control a display state of the display panel 11. That is, the CPU 12 fetches this display control program from the memory 13 to execute it, thereby realizing the function (which will be described in detail later) of the display control section.

Still furthermore, in the present invention, it is also appropriate that, in order to realize the display function in a computer system (for example, the PC 2 shown in FIG. 24B) equipped with a displaying section such as an LCD, a PDP, a CRT or the like, the aforesaid display control program is made as an application program to be provided in the form recorded in a computer-readable recording medium such as a flexible disk or a CD-ROM.

In this case, the computer system reads out the display control program from that recording medium and transfers it to an internal storage device or an external storage device for storage. When the display function is needed, the computer system reads out the display control program from the storage device and executes it. At this time, the computer system can directly read out and execute the display control program recorded in the recording medium.

Alternatively, it is also acceptable that the display control program is once recorded in a storage device, such as a magnetic disk, optical disk or magneto optical disk, and then given from that storage device through a communication line to the computer system.

Among the recording mediums for recording the display control program, in addition to the aforesaid flexible disk, CD-ROM, DVD, magnetic disk, optical disk and magneto optical disk, there are various types of computer-readable mediums, such as IC card, ROM card, magnetic data, punch card, internal storage device (memory such as RAM or ROM) of a computer, an external storage device, a printed matter including a bar code or other codes.

The display control program includes a program code for realizing the function of the display control section in such a computer system (CPU 12 or PC 2). In addition, it is also possible that a part of that function is fulfilled with an operating system without depending on the display control program.

In a case in which the display function according to the present invention is realized with a computer system such as a PC as stated above, then a keyboard, a mouse or the like serves as the input unit 14 of the display apparatus 10 according to this embodiment.

A detailed description will be given hereinbelow of the function of the display control section realizable by the CPU 12.

In a case in which the CPU 12 implements the aforesaid display control program to function as means for providing the reading display mode for displaying the whole of each page (contents of each page) of the document contents on the display panel 11, means for providing the two kinds of automatic paging display modes (cursory reading display mode and general view display mode) for conducting paging at different speeds and successively displaying partially or schematically each page of the document contents on the display panel 11 according to a display method corresponding to an established speed, and the display control section, it controls the display state of the display panel 11 to display the document contents on the display panel in one display mode selected from the aforesaid three kinds of display modes.

The reading display mode is equivalent to the careful reading behavior mentioned above with reference to FIG. 2A, and on the selection of this reading display mode, the CPU 12 controls the display state of the display panel 11 to display the whole of each page of the document contents on the display panel 11.

The cursory reading display mode (first automatic paging display mode) is equivalent to the skimming behavior mentioned above with reference to FIG. 2B, and on the selection of this cursory reading display mode, the CPU 12 controls the display state of the display panel 11 to make a display on the display panel 11 so that the outline of each page is seizable to a reader.

The general view display mode (second automatic paging display mode) is equivalent to the glancing mentioned above with reference to FIG. 2C, and on the selection of this general view display mode, the CPU 12 controls the display state of the display panel 11 so that the paging is conducted at a speed higher than that of the cursory reading display mode and the whole of each page is generally viewable to a reader.

At this time, the input unit 14 functions as a selecting means to select one of the reading display mode and the plurality of automatic paging display modes, and a reader, using the display apparatus 10, manipulates the input unit 14, thus inputting a display mode selection instruction to the CPU 12.

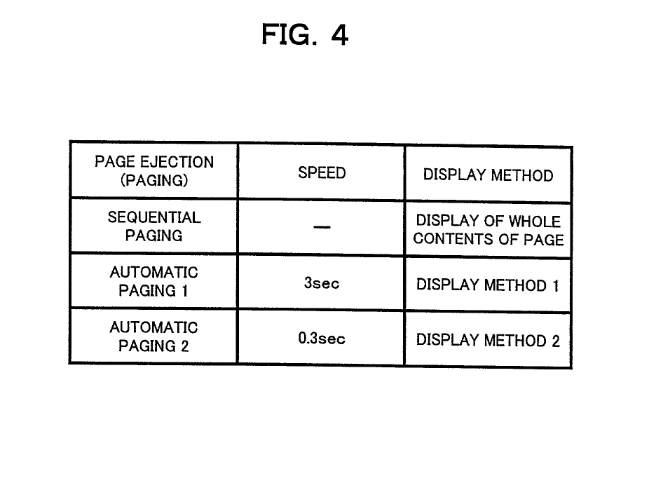

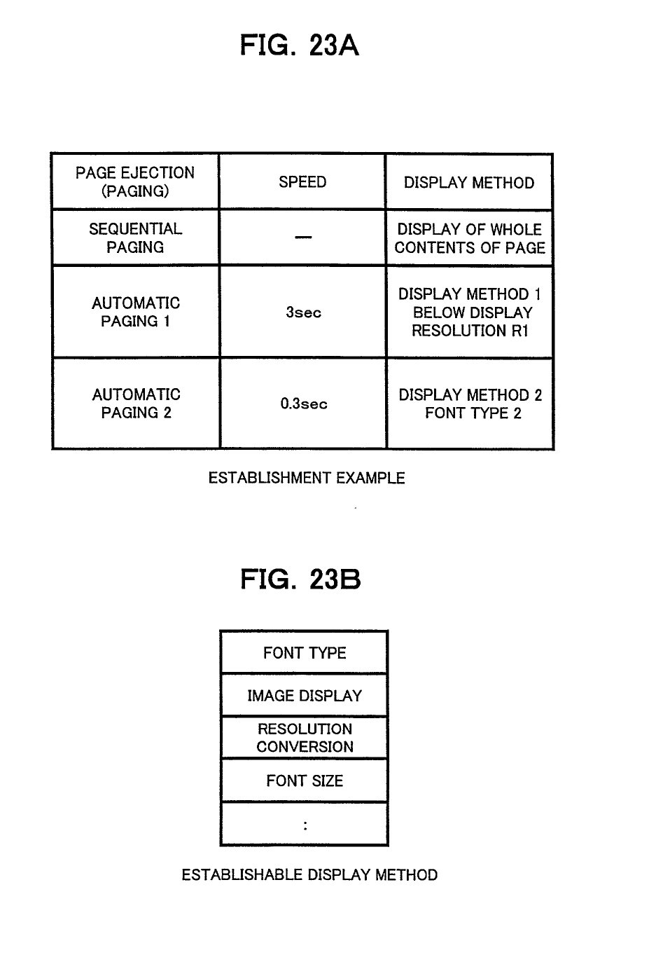

In addition, in the display apparatus 10 according to this embodiment, as will be described later with reference to FIG. 23A or 23B, the input unit 14 also functions as an establishing means to individually set a paging speed or a display method in the case of each of automatic paging display modes, and a reader, using the display apparatus 10, manipulates the input unit 14 to set/alter a display operation in each display mode. The established data inputted through the input unit 14 is registered/set in an establishment table (see FIGS. 4, 6A, 6B, 12, 13, 16, 18, 20, 22 and 23A) in the memory 13.

(3) Description of Display Processing in Display Apparatus According to the Embodiment

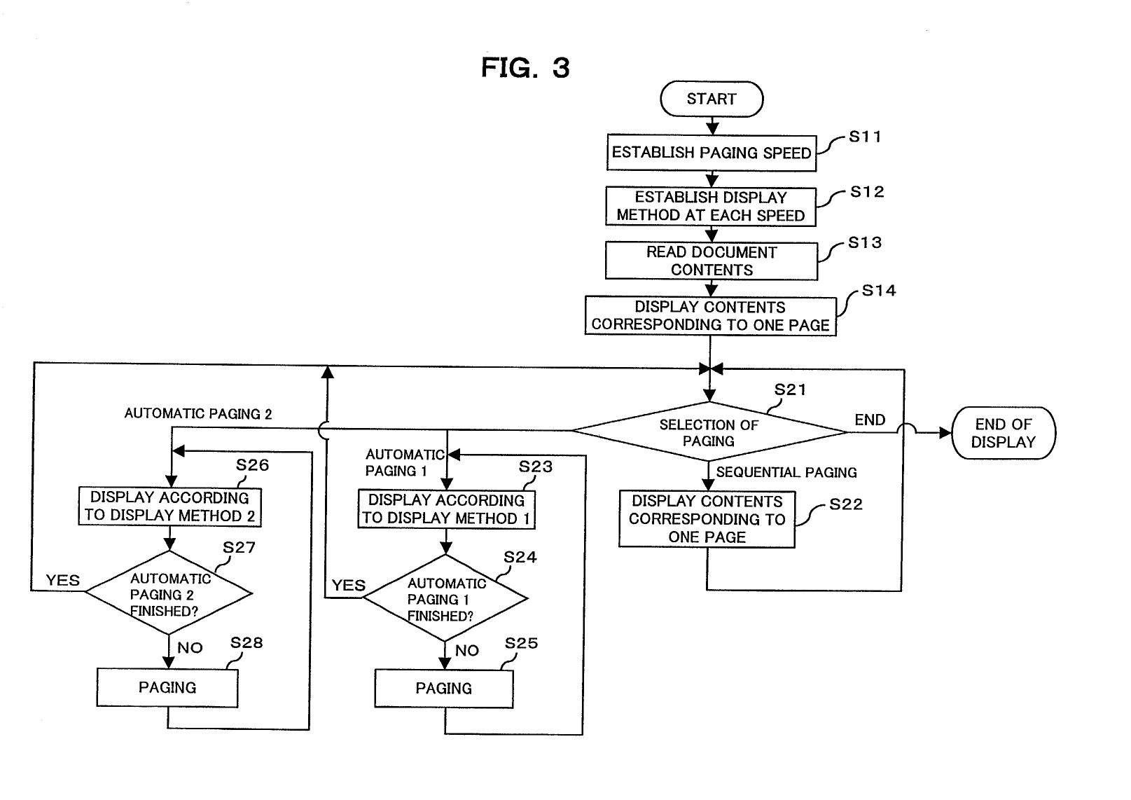

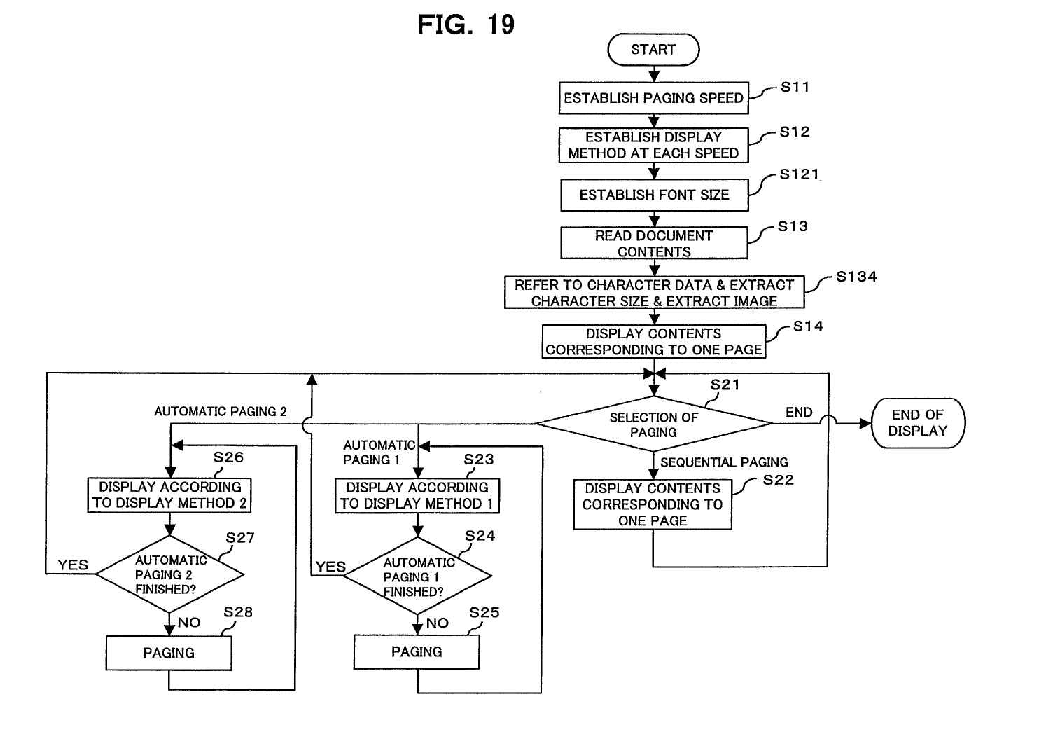

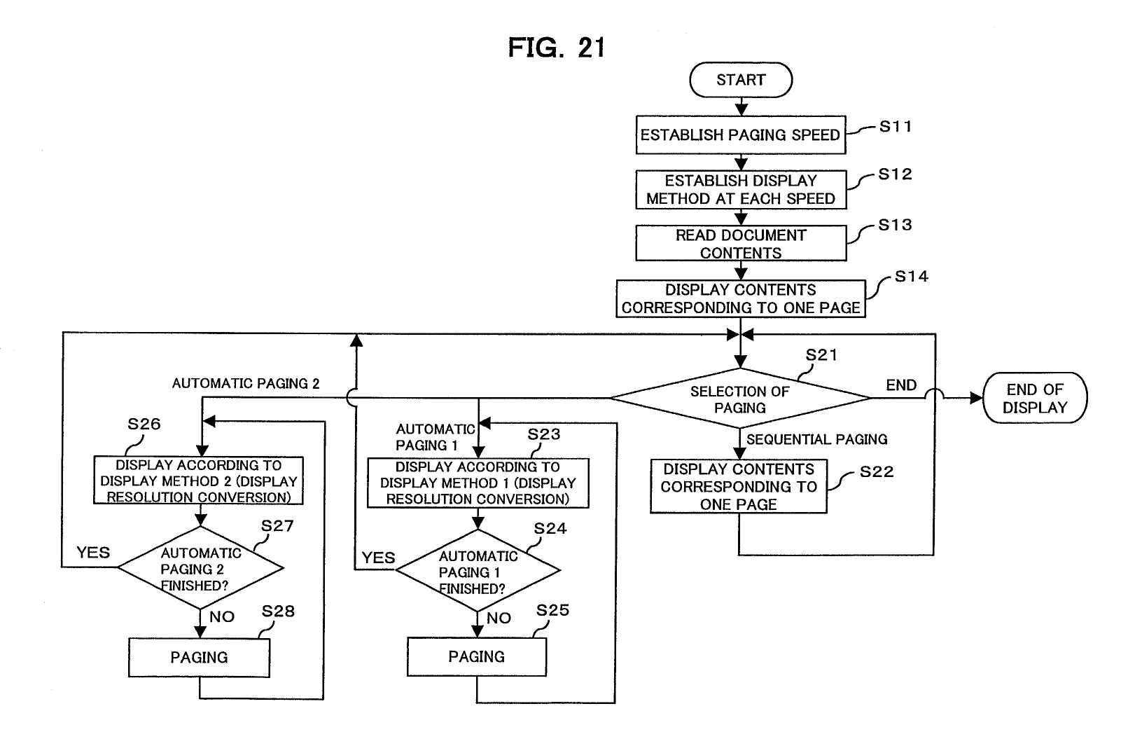

Referring to FIGS. 3 to 23B, a description will be given hereinbelow of the display processing in the display apparatus 10 according to this embodiment constructed as described above and an establishing method of each display mode.

(3-1) Description of First Example of Display Processing

A first example of display processing in the display apparatus 10 according to this embodiment will be described hereinbelow with reference to FIG. 4 and a flow chart (steps S11 to S14 and S21 to S28) of FIG. 3. FIG. 4 is an illustration of establishment contents (establishment table) of display modes in the first example of the display processing.

In the first display processing example, when the display apparatus 10 is put in operation, a reader first uses the input unit 14 to set a paging speed (display time per page) in each automatic paging display mode (step S11), and to set a display method in each automatic paging display mode (each speed) (step S12).

In the display apparatus 10 according to this embodiment, as stated above, it is possible to set/select one of the sequential paging in which the whole page contents are displayed according to page regardless of time and paging is conducted in units of one page in accordance with an instruction from the reader and the two kinds of automatic paging in which paging is conducted automatically at a constant time interval.

In this first display processing example, as FIG. 4 shows, the paging speed of the automatic paging 1 is set at 3 seconds and the paging speed of the automatic paging 2 is set at 0.3 seconds, while the whole page contents are displayed in the case of the sequential paging, the page display is made according to the display method 1 in the case of the automatic paging 1, and the page display is made according to the display method 2 in the case of the automatic paging 2.

These display methods 1 and 2 are made to display a portion extracted/selected from the whole page or to schematically display the whole page, without displaying the entire contents at the display of each page. Although concrete display methods will be described in the third to eighth examples of display processing, the establishment of a display method causes any one of, for example, partial display according to a font size or font type, partial display involving extraction of a picture, graph or the like, schematic display involving a document layout image (character crushed image) and schematic display based on display resolution conversion to be made in each automatic paging display mode.

In this connection, in the case of the employment of a speed and display method established previously as default values in the establishment table, the establishment processing in the steps S11 and S12 are omissible.

After the completion of the establishment mentioned above, in the display apparatus 10, the document contents to be displayed on the display panel 11 are read (step S13), and the data corresponding to the first page is evolved in the memory 13 and then displayed on the display panel 11 (step S14).

Furthermore, the reader makes the selection of paging (display mode) with respect to the contents displayed on the display panel 11 (step S21). As mentioned above, the selection instruction is by the manipulation of the input unit 14.

In the case of the selection of the sequential paging (“sequential paging” route from step S21), the next whole contents are displayed on the display panel 11 (step S22), and the operational flow returns to the step S21.

For the section of the automatic paging 1 (“automatic paging 1” route from step S21), the page display is made according to the display method 1 set in the step S12 (step S23), and the paging is conducted at the paging speed set in the step S11 (from step S24 through “NO” route to step S25) until input of an instruction for finish of the automatic paging 1 (until “YES” decision in step S24). In the meantime, the page display according to the display method 1 is made continuously. Upon the input of the finish instruction on the automatic paging 1 (“YES” route from step S24), the operational flow returns to the step S21.

Likewise, for the selection of the automatic paging 2 (“automatic paging 2” route from step S21), the page display is made according to the display method 2 set in the step S12 (step S26). Until the input of an instruction for finish of the automatic paging 2 (“YES” decision in step S27), the page display according to the display method 2 is made continuously in a state where the paging is conducted at a paging speed set in the step S11 (from step S27 through “NO” route to step S28). Upon the input of the finish instruction on the automatic paging 2 (“YES” route from step S27), the operational flow returns to the step S21.

In addition, in the step S21, if a paging finish instruction is issued (“end” route), the display on the display panel 11 comes to an end. For example, the paging finish instruction is inputted by manipulating a finishing key or the like included in the input unit 14.

(3-2) Description of Second Example of Display Processing

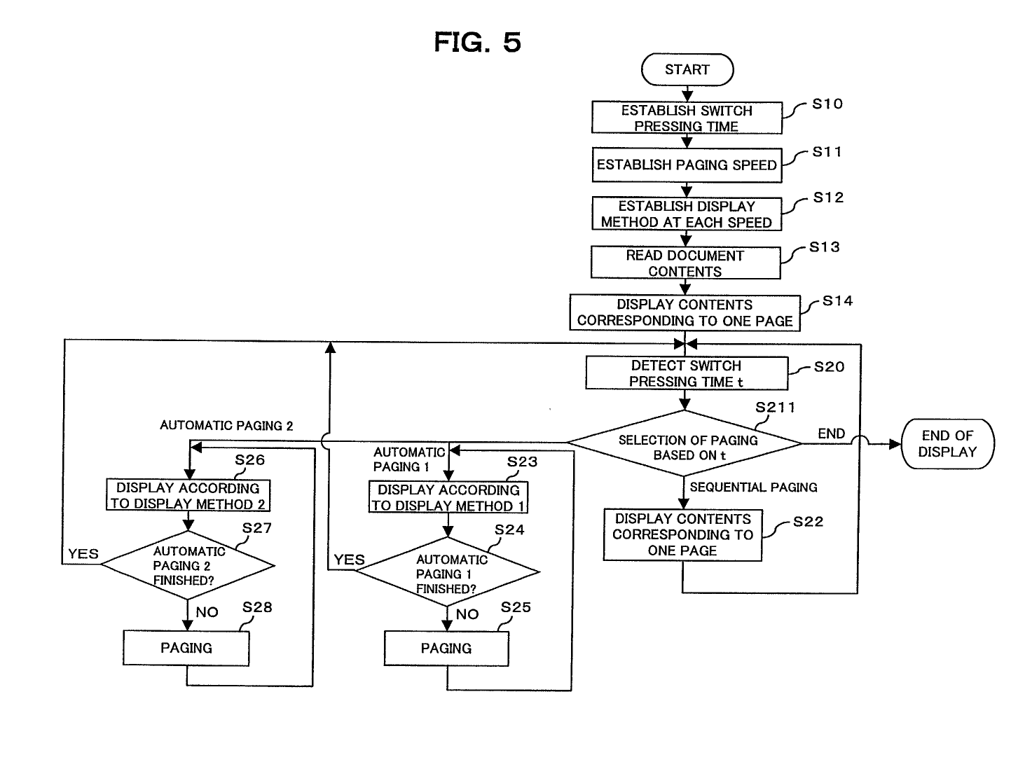

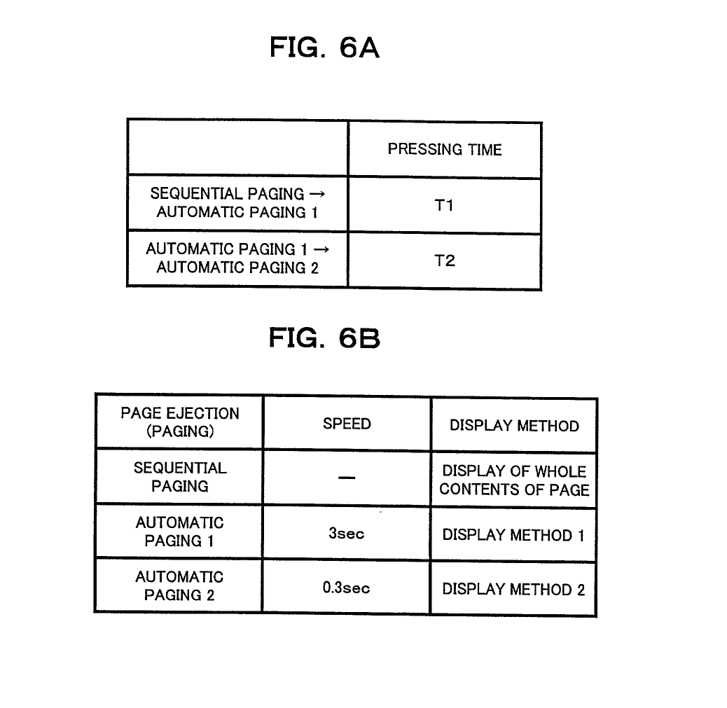

A second example of display processing in the display apparatus 10 according to this embodiment will be described hereinbelow with reference to FIGS. 6A, 6B, and a flow chart (steps S10 to S14, S20, S211, and S22 to S28) of FIG. 5. FIG. 6A is an illustration of an establishment example of a display mode switching reference (paging switch pressing time in a second example of display processing, while FIG. 6B is an illustration of establishment contents (establishment table) of each display mode in this second example.

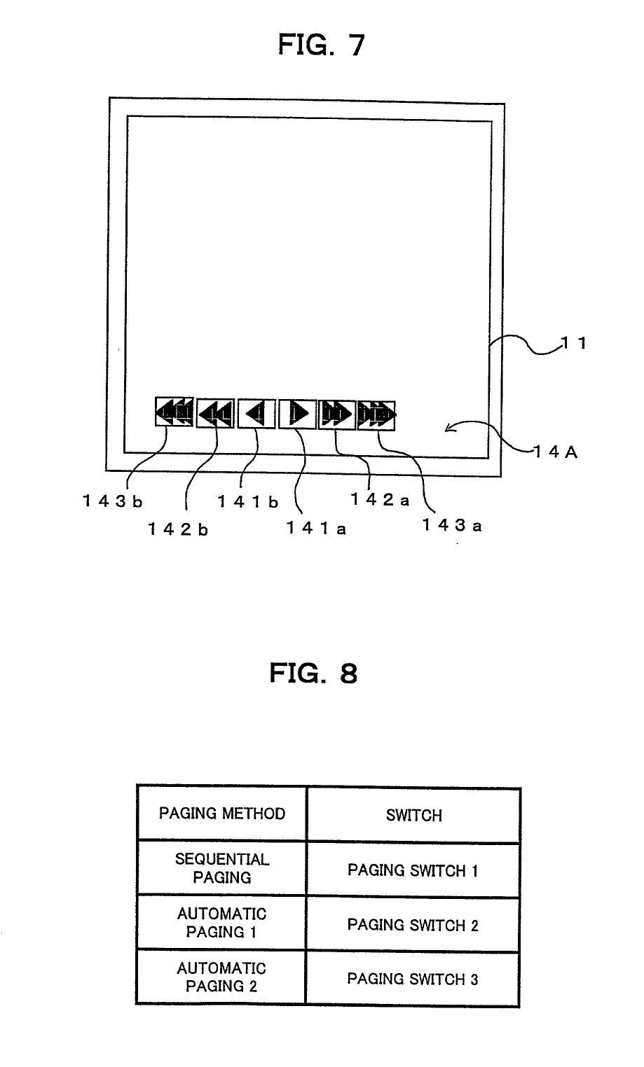

In this second example, as the input unit (selecting means) 14, a pair of paging switches are provided in the form of hardware keys or software keys (for example, denoted at numerals 141a and 141b in FIG. 7) displayed on the display panel 11. When one of these switches is manipulated, the paging is conducted in the next page direction, while on the manipulation of the other, the paging is made in the previous page direction. Through the use of such paging switches, any one of the sequential paging, the automatic paging 1 and the automatic paging 2 is selected (selection of paging) as will be described herein later.

In the second display processing example, when the display apparatus 10 is put in operation, a reader first uses the input unit 14 to set a switch pressing time/manipulation time which forms a decision reference (display mode switching reference) at selection of paging (step S10). The time set here is registered in the establishment table, for example shown in FIG. 6A, in the memory 13. Incidentally, in the case of the employment of a switching reference time set previously as a default value in the establishment table, the establishment processing in the step S10 is omissible.

In the establishment table as shown in FIG. 6A, T1 is set as the switching reference time from the “sequential paging” to “automatic paging 1”, while, T2 is set as the switching reference time from the “automatic paging 1” to “automatic paging 2”, where T1<T2.

In addition, in the second example, the CPU 12 has a function to measure and detect the paging switch pressing time t and a function to compare the time t detected by the first-mentioned function with the switching reference times T1 and T2.

Accordingly, when the paging switch is manipulated for a short time shorter than the switching reference time T1, the “sequential paging” is selected and implemented, and when the continuous paging switch pressing time exceeds the switching reference time T1, the “automatic paging 1” is selected and carried out, and further, when the continuous paging switch pressing time exceeds the switching reference time T2, the “automatic paging 2” is selected and carried out.

Naturally, when a paging switch (for example, denoted at numeral 141a in FIG. 7) is pressed continuously in the next page direction, the automatic paging display mode is switched on the next page direction, and when a paging switch (for example, denoted at numeral 141b in FIG. 7) is pressed continuously in the previous page direction, the automatic display mode is switched on the previous page direction.

After the establishment of the switching reference times T1 and T2, as well as the first example, the reader sets a paging speed in each automatic paging display mode (step S11), and sets a display method in each automatic paging display mode (each speed) (step S12). An establishment example is shown in FIG. 6B, with the establishment contents in FIG. 6B being identical to the establishment contents in the first example shown in FIG. 4.

After the establishment of the speed and the display method, the document contents to be displayed on the display panel 11 are read (step S13), and the data corresponding to the first page is evolved in the memory 13 and then displayed on the display panel 11 (step S14).

Furthermore, the pressing time t of the paging switch, manipulated by the reader, is detected (step S20), and the selection of the paging (display mode) is made as mentioned above on the basis of the detected pressing time t and the switching reference times T1 and T2 (step S211).

When the paging switch is manipulated briefly so that the pressing time t does not reach the switching reference time T1, the sequential paging is selected (“sequential paging” route in step S211), and the whole contents of the next page (or the previous page) are displayed on the display panel 11 (step S22), and then followed again by the step S20.

If the continuous paging switch pressing time t exceeds the switching reference time T1, the display mode shifts automatically from the sequential paging to the automatic paging 1 (“automatic paging 1” route from step S211), and as in the case of the first example, the processing (steps S23 to S25) are implemented, and upon the input of an instruction for finish of the automatic paging 1 (“YES” route from step S24), the operational flow returns to the step S20.

Furthermore, if the continuous paging switch pressing time t exceeds the switching reference time T2, the display mode shifts automatically from the automatic paging 1 to the automatic paging 2 (“automatic paging 2” route from step S211), and as in the case of the first example, the processing (steps S26 to S28) are implemented, and upon the input of an instruction for finish of the automatic paging 2 (“YES” route from step S27), the operational flow returns to the step S20.

In this connection, in the step S211, as with the first example, when an instruction for finish of the paging is issued (“end” route), the display on the display panel 11 comes to an end. The input of the paging finish instruction is, for example, by manipulation of a finishing key or the like included in the input unit 14.

In this way, in the second display processing example, the display mode to be selected is determined as a function of the time of pressing of the paging switch by the reader, thus automatically switching the display mode.

In the second display processing example, as described above, the selection/switching of the display mode is made as a function of the continuous paging switch pressing time. Secondly, referring to FIGS. 7 to 10, a description will be given hereinbelow of a modification of the display mode selection method (display mode selection method using a plurality of paging switches).

(3-2-1) First Modification of Display Mode Selection Method

FIG. 7 is an illustration useful for explaining a first modification of the display mode selection method in the second display processing example, and FIG. 8 is an illustration of an establishment example of a display mode switching reference (paging switch manipulating method) in the first modification.

In this first modification, as FIG. 7 shows, three types of paging switches 141a, 142a and 143a for next page direction and three types of paging switches 141b, 142b and 143b for previous page direction are provided as input unit (selecting means) 14A in a state displayed in a lower section of a display area of the display panel 11. When a reader presses these switches 141a to 143a or 141b to 143b through the use of a touch pen or the like, any one of the sequential paging, the automatic paging 1 and the automatic paging 2 is selected (selection of paging).

That is, the paging switches 141a, 142a and 143a for the next page direction correspond to the sequential paging, the automatic paging 1 and the automatic paging 2, respectively, and the paging switches 141b, 142b and 143b for the previous page direction correspond to the sequential paging, the automatic paging 1 and the automatic paging 2, respectively, so that the sequential paging is selected when the paging switch 141a or 141b is pressed once, the automatic paging 1 is selected when the paging switch 142a or 142b is pressed once, and the automatic paging 2 is selected when the paging switch 143a or 143b is pressed once.

In the first modification, the above-mentioned association between the sequential paging, the automatic paging 1, 2 and the paging switches 141a to 143a or 141b to 143b is registered/set previously as a display mode switching reference (manipulation method) as shown in FIG. 8. The establishment of this association is made in place of the above-mentioned time establishment in the step S10 in FIG. 5. However, in a case in which the switching reference (for example, see FIG. 8) set in advance as a default value in the establishment table is directly put to use, the establishment processing in the step S10 is omissible.

Accordingly, in the first modification, the step S20 in FIG. 5 is omitted, and in the step S211, the judgment on the paging switch manipulated by the reader takes place, thereby selecting the paging (display mode).

(3-2-2) Second Modification of Display Mode Selection Method

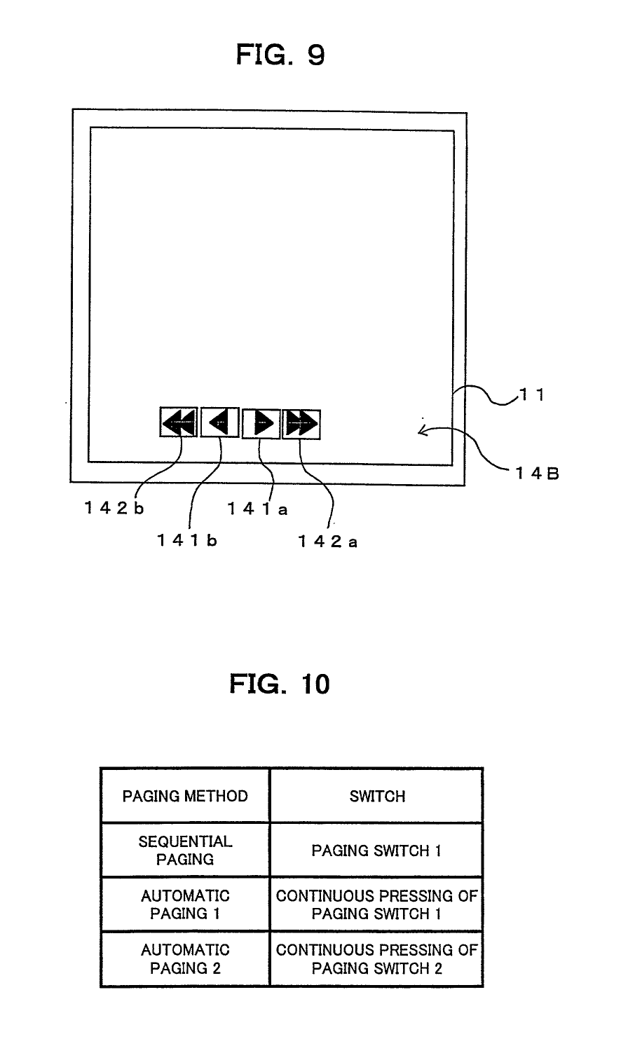

FIG. 9 is an illustration useful for explaining a second modification of the display mode selection method in the second display processing example, and FIG. 10 is an illustration of an establishment example of a display mode switching reference (paging switch manipulating method) in the second modification.

In the second modification, as FIG. 9 shows, two types of paging switches 141a, 142a for the next page direction and two types of paging switches 141b, 142b for the previous page direction are provided as input unit (selecting means) 14B in a state displayed in a lower section of a display area of the display panel 11. When a reader presses these switches 141a, 142a or 141b, 142b according to a predetermined manipulation manner through the use of a touch pen or the like, any one of the sequential paging, the automatic paging 1 and the automatic paging 2 is selected (selection of paging).

In this case, for example, as FIG. 10 shows, the association between the sequential paging, the automatic paging 1, the automatic paging 2 and switches to be manipulated, the corresponding manipulation method is registered/set previously as a display mode switching reference. This association is set in place of the time establishment in the step S10 of FIG. 5.

In the establishment example as shown in FIG. 10, when the paging switch 141a or 141b is once pressed briefly (for example, in the case of a pressing time shorter than 0.1 second), the sequential paging is selected, while the continuous pressing of the paging switch 141a or 141b selects the automatic paging 1, and the continuous pressing of the paging switch 142a or 142b selects the automatic paging 2.

Accordingly, in the second example, the pressing time t of the paging switch pressed by a reader is detected (step S20), and the paging (display mode) selection is made on the basis of the type of the paging switch manipulated by the reader and the pressing time t thereof and according to the establishment table shown in FIG. 10.

In this connection, in a case in which the display mode selection is made through the use of a plurality of paging switches, as the manipulation methods forming a switching reference, in addition to the above-described first and second modifications, various kinds of manipulation methods [for example, a switch is pressed twice continuously (double-click)] are also acceptable in accomplishing the switching/selection among the sequential paging, the automatic paging 1 and the automatic paging 2.

In addition, the display mode selection method described in the second example (including the first and second modifications) is also applicable to third to eighth examples, which will be described hereinafter, as in the case of the above-described second example.

(3-3) Description of Third Example of Display Processing

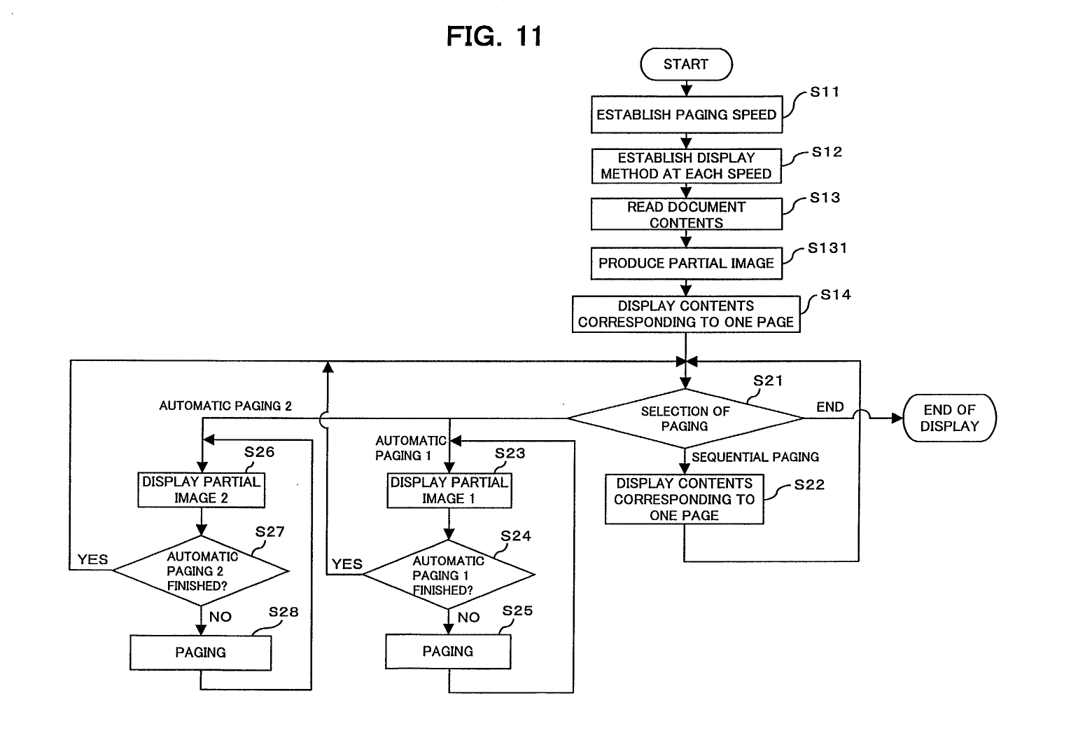

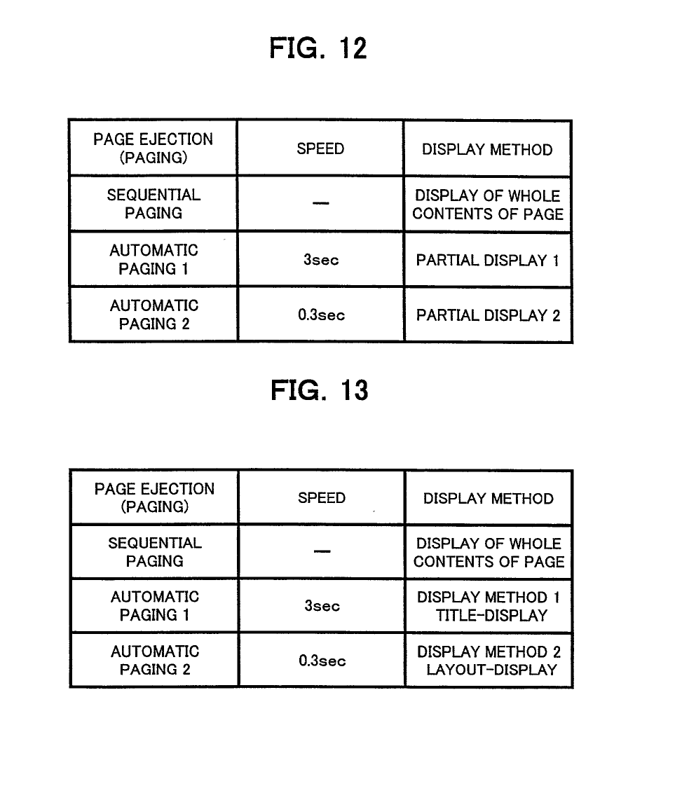

A third example of display processing in the display apparatus 10 according to this embodiment will be described hereinbelow with reference to FIG. 12 and a flow chart (steps S11 to S14, S21 to S28 and S131) of FIG. 11. FIG. 12 is an illustration of establishment contents (establishment table) in display modes in the third display processing example.

Also in this third display processing example, as with the first example, when the display apparatus 10 is placed in operation, a reader first uses the input unit 14 to set a paging speed in each automatic paging display mode (step S11), and to set a display method in each automatic paging display mode (each speed) (step S12).

An establishment example in the third example is shown in FIG. 12. In the establishment table shown in FIG. 12, the paging speed for the automatic paging 1 is set at three seconds and the paging speed for the automatic paging 2 is set at 0.3 second, while the whole contents of each page are displayed in the case of the sequential paging, a partial display 1 for the automatic paging 1, and a partial display 2 for the automatic paging 2.

Furthermore, after such establishment, the document contents to be displayed on the display panel 11 are read (step S13), and in this third example, two kinds of partial images are produced at every page and stored in the memory 13 in order to accomplish the partial display 1 and the partial display 2 (step S131).

In each of the partial display 1 and the partial display 2, an element meeting a predetermined condition is extracted from document elements constituting each page to produce a partial image which in turn, is displayed. Accordingly, for example, in a case in which display of characters each having a font size above a given value L is set as the partial display 1, in the step S131, characters having a font size above L are located at a predetermined position on the basis of the font information and character position information on the document contents, thus producing the partial image 1 for each page. In addition, as with the partial display 1 but under a display establishment condition different from that of the partial display 1, the partial display 2 is produced for each page.

Following this, the processing (steps S14 and S21 to S28) similar to the first display processing example shown in FIG. 3 takes place.

In the third example, however, when the automatic paging 1 is selected in the step S21 (“automatic paging 1” route from step S21), the partial image 1 for the partial display 1 produced in the step S131 is displayed in the step S23. In like manner, when the automatic paging 2 is selected in the step S21 (“automatic paging 2” route from step S21), the partial image 2 for the partial display 2 produced in the step S131 is displayed in the step S26.

In this way, in the third display processing example, a partial image produced under a condition set according to display mode (paging speed) is displayed in each automatic paging display mode, thereby automatically conducting the paging at an established speed while partially displaying the contents of each page.

(3-4) Description of Fourth Example of Display Processing

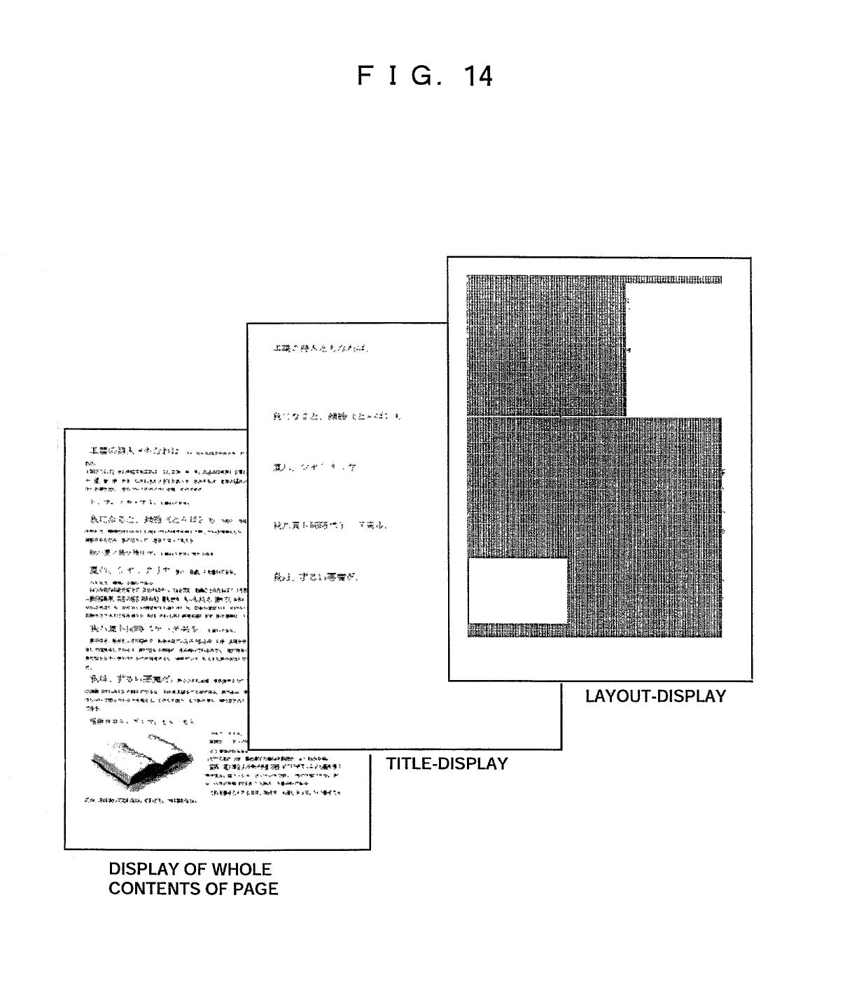

FIG. 13 is an illustration of establishment contents (establishment table) for display modes in a fourth example of display processing in the display apparatus 10 according to this embodiment, and FIG. 14 is an illustration of a concrete display example in the display modes in the fourth display processing example.

In the fourth display processing example, a description will be given hereinbelow of more concrete establishment shown in FIG. 13, instead of the establishment shown in FIG. 4, 6B or 12.

That is, even the establishment example shown in FIG. 13, the paging speed for the automatic paging 1 is set at three seconds, the paging speed for the automatic paging 2 is set at 0.3 second, and the whole contents of each page are displayed in the case of the sequential paging, while the display method 1 for the title display, that is, for when only a title is extracted from each page and displayed, is set with respect to the automatic paging 1, and the display method 2 for the layout display, that is, for when an layout of each page is displayed illustratively, is set with respect to the automatic paging 2. Incidentally, in the case of the aforesaid title display, in fact, fonts with size above a predetermined font size are extracted for the display.

With the display processing according to the above-described establishment, in the step S22 of FIG. 3, 5 or 11, the display of the whole contents of each page takes place as shown in a left side of FIG. 14, and in the step S23 of FIG. 3, 5 or 11, the tile display takes place at every page as shown in a central portion of FIG. 14, and further, in the step S26 of FIG. 3, 5 or 11, the layout display takes place at every page as shown in a right side of FIG. 14.

(3-5) Description of Fifth Example of Display Processing

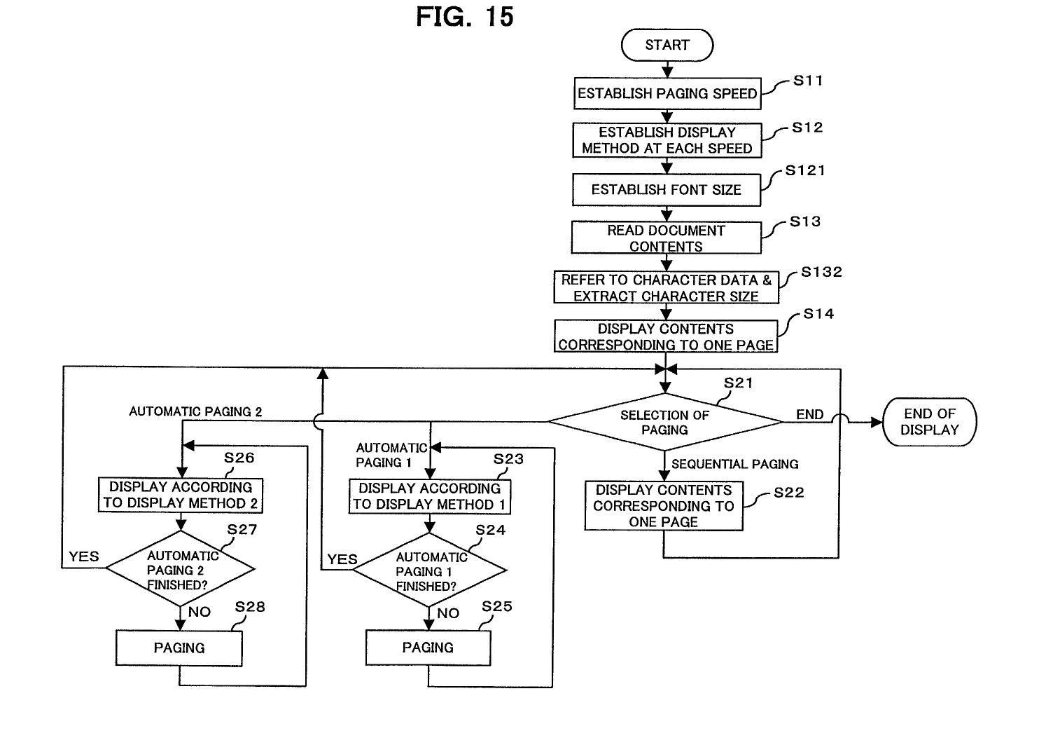

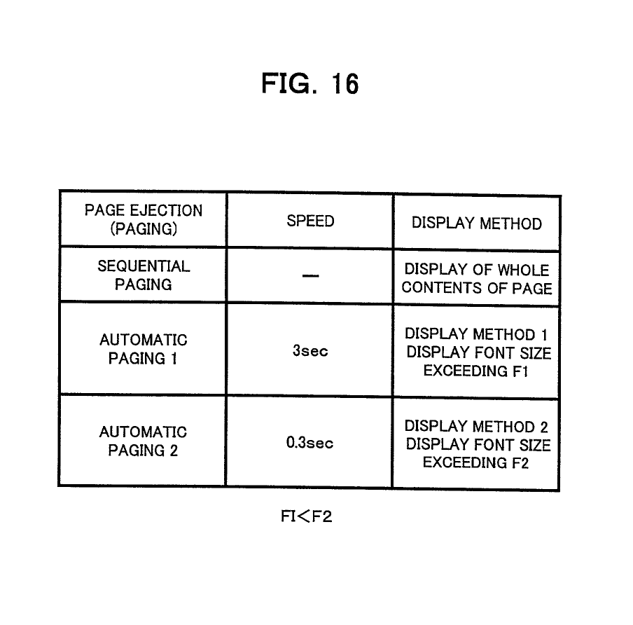

A fifth example of display processing in the display apparatus 10 according to this embodiment will be described hereinbelow with reference to FIG. 16 and a flow chart (steps S11 to S14, S21 to S28, S121 and S132) of FIG. 15. FIG. 16 is an illustration of establishment contents (establishment table) in display modes in the fifth display processing example.

Also in the fifth display processing example, as with the first example, when the display apparatus 10 is placed in operation, a reader uses the input unit 14 to set a paging speed in each automatic paging display mode (step S11), and to set a display method in each automatic paging display mode (each speed) (step S12).

An establishment example in the fifth example is shown in FIG. 16. In the establishment table as shown in FIG. 16, the paging speed for the automatic paging 1 is set at three seconds, the paging speed for the automatic paging 2 is set at 0.3 second, and the whole contents of each page are displayed in the case of the sequential paging, while in the case of each of the automatic paging 1 and the automatic paging 2, the page display is made according to the display method 1 or the display method 2 based on a font size condition.

At this time, the font size condition is set with respect to each of the display method 1 and the display method 2 (step S121). In this step S121, for example, font sizes F1 and F2 are set through the input unit 14 so that fonts exceeding the font size F1 are taken for the display method 1 while fonts exceeding the font size F2 (>F1) are taken for the display method 2. Incidentally, it is also acceptable that, in place of the font sizes F1 and F2 being previously set in this way, a list of font sizes in a page is made out so that the maximum font size therein is taken as F2 while a font size smaller by a given value than F2 is taken as F1.

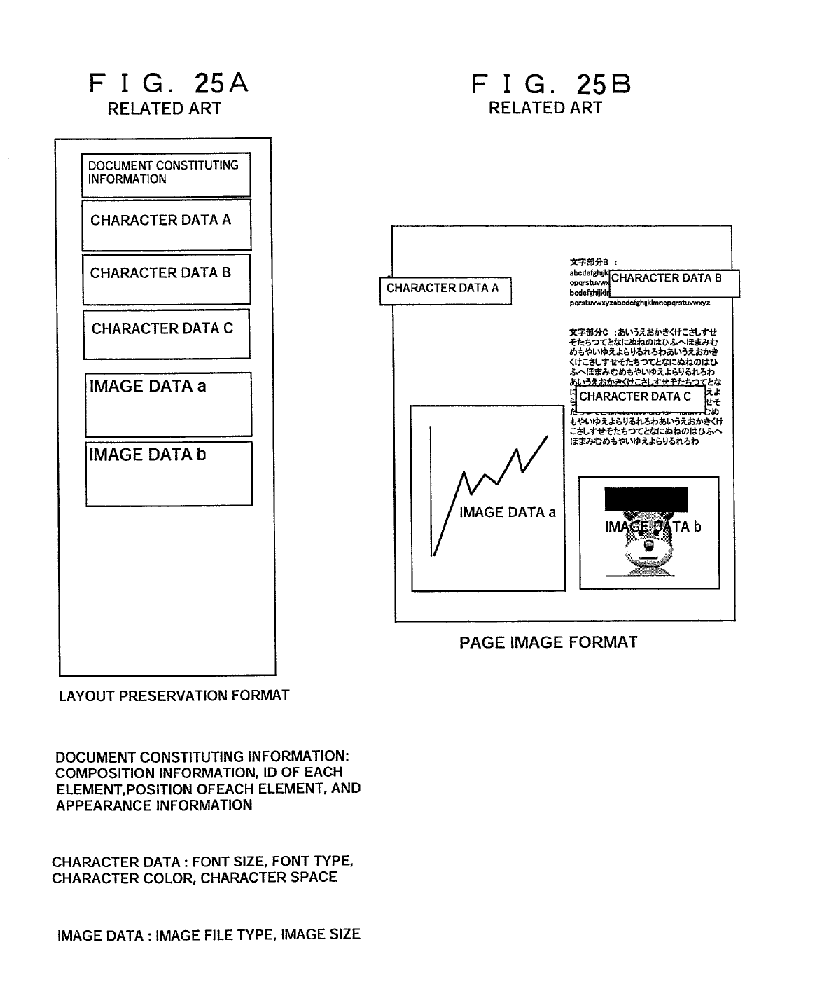

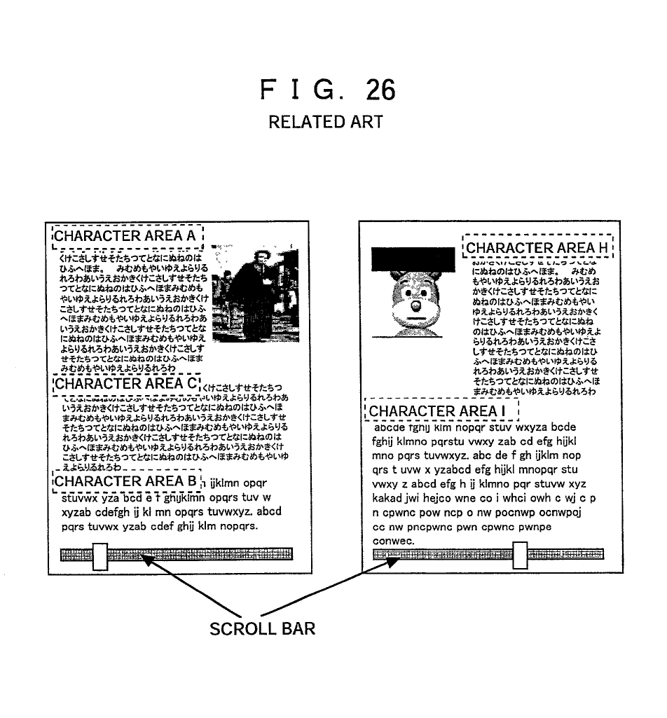

After this establishment, the document contents to be displayed on the display panel 11 are read (step S13), and in this fifth example, the CPU 12 refers to character data (for example, see FIG. 25A) of the document contents to produce a partial image 1 (an image made in a manner that characters having font sizes above F1 are extracted and located at a predetermined position) for the page display according to the display method 1 and a partial image 2 (an image made in a manner that characters having font sizes above F2 are extracted and located at a predetermined position) for the page display according to the display method 2 for each page, and puts them in the memory 13 (step S132).

Thereafter, the processing (steps S14 and S21 to S28) similar to the first display processing example 1 shown in FIG. 3 takes place.

In the fifth example, however, if the automatic paging 1 is selected in the step S21 (“automatic paging 1” route from step S21), the partial image 1 produced in the step S132 is taken as the display according to the display method 1 in the step S23 so that the characters exceeding the font size F1 are displayed at each page. In like manner, if the automatic paging 2 is selected in the step S21 (“automatic paging 2” route from step S21), the partial image 2 produced in the step S132 is taken as the display according to the display method 2 in the step S26 so that the characters exceeding the font size F2 are displayed at each page.

In this way, in the fifth display processing example, in each automatic paging display mode, a partial image produced on a font size condition set according to display mode (paging speed) is displayed, thereby automatically conducting the paging at an established speed while partially displaying the contents of each page.

(3-6) Description of Sixth Example of Display Processing

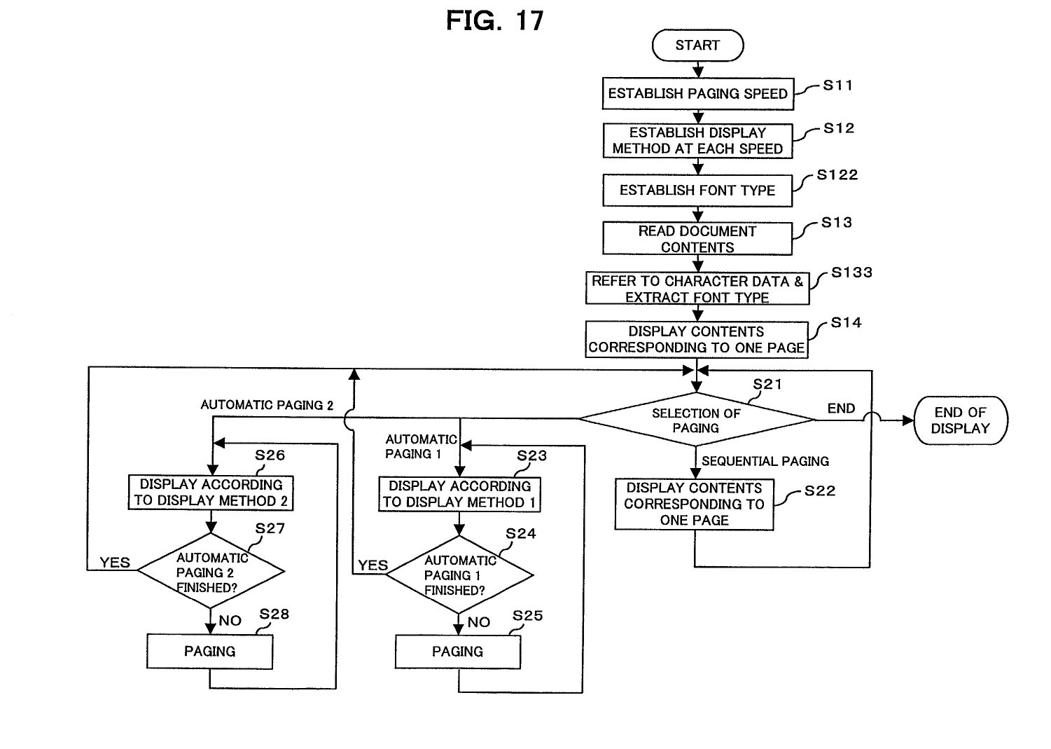

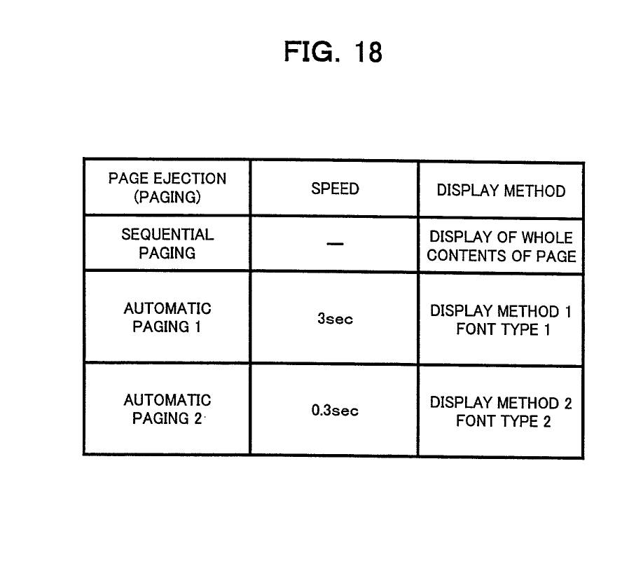

A sixth example of display processing in the display apparatus according to this embodiment will be described hereinbelow with reference to FIG. 18 and a flow chart (steps S11 to S14, S21 to S28, S122 and S133) of FIG. 17. FIG. 18 is an illustration of establishment contents (establishment table) in display modes in the sixth display processing example.

Also in the sixth display processing example, as with the first example, when the display apparatus 10 is placed in operation, through the use of the input unit 14, a reader first sets a paging speed in each automatic paging display mode (step S11), and sets a display method in each automatic paging display mode (each speed) (step S12).

An establishment example of the sixth example is shown in FIG. 18. In the establishment table shown in FIG. 18, the paging speed for the automatic paging 1 is set at three seconds, the paging speed for the automatic paging 2 is set at 0.3 second, and the whole contents of each page are displayed in the case of the sequential paging, while in the case of each of the automatic paging 1 and the automatic paging 2, the page display is made according to the display method 1 or the display method 2 based on a font type condition.

At this time, a font type condition is set for each of the display method 1 and the display method 2 (step S122). In this step S122, for example, a font type 1 and a font type 2 are inputted and set through the use of the input unit 14 so that fonts with the font type 1 are taken for the display method 1 while fonts with the font type 2 are taken for the display method 2. As the font types, in addition to thick characters and read characters for emphasis, for example, there are set character styles (Gothic style, Italic style, Ming style or the like). More concretely, the Gothic style and the italic style are set as the font type 1, and the Gothic style and italic style with a color other than black or of bold face are set as the font type 2.

After the establishment made in this way, the document contents to be displayed on the display panel 11 are read (step S13), and in the sixth example, the CPU 12 refers to character data (for example, see FIG. 25A) of the document contents to produce a partial image 1 (an image made in a manner that characters having the font type 1 are extracted and located at a predetermined position) for the page display according to the display method 1 and a partial image 2 (an image made in a manner that characters having the font type 2 are extracted and located at a predetermined position) for the page display according to the display method 2 for each page, and puts them in the memory 13 (step S133).

Thereafter, the processing (steps S14 and S21 to S28) similar to the first display processing example shown in FIG. 3 takes place.

In the sixth example, however, when the automatic paging 1 is selected in the step S21 (“automatic paging 1” route from step S21), the partial image 1 produced in the step S133 is displayed as the display according to the display method 1 in the step S23. Thus, characters with the font type 1, such as Gothic or italic, are displayed at every page.

Likewise, when the automatic paging 2 is selected in the step S21 (“automatic paging 2” route from step S21), the partial image 2 produced in the step S133 is displayed as the display according to the display method 2 in the step S26. Accordingly, characters with the font type 2, such as the Gothic or italic style with a color other than black or bold face, are displayed at every page.

In this way, in the sixth display processing example, in each automatic paging display mode, a partial image produced under a font type condition set according to display mode (paging speed) is displayed, thus automatically conducting the paging at an established speed while partially displaying the contents of each page.

(3-7) Description of Seventh Example of Display Processing

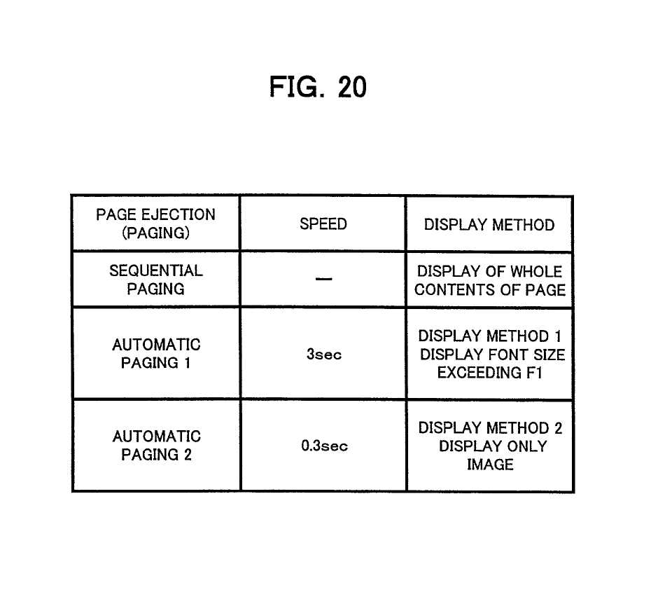

A seventh example of displaying processing in the display apparatus 10 according to this embodiment will be described hereinbelow with reference to FIG. 20 and a flow chart (steps S11 to S14, S21 to S28, S121 and S134). FIG. 20 is an illustration of establishment contents (establishment table) in display modes in the seventh display processing example.

Also in the seventh display processing example, as with the first example, when the display apparatus 10 is put in operation, through the use of the input unit 14, a reader sets a paging speed in each automatic paging display mode (step S11), and sets a display method in each automatic paging display mode (each speed) (step S12).

An establishment example of the seventh example is shown in FIG. 20. In the establishment table shown in FIG. 20, the paging speed for the automatic paging 1 is set at three seconds, the paging speed for the automatic paging 2 is set at 0.3 second, and the whole contents of each page are displayed in the case of the sequential paging, while in the case of the automatic paging 1, the page display is made according to the display method 1 based on a font size condition, and in the automatic paging 2, the page display is made according to the display method 2 of extracting and displaying only an image on each page.

At this time, the font size condition for the display method 1 is set in the step S121 as in the case of the fifth example. In this step S121, for example, the font size F1 is inputted and set through the use of the input unit 14 so that the characters with fonts exceeding the font size F1 are displayed according to the display method 1.

After the establishment made in this way, the document contents to be displayed on the display panel 11 are read (step S13), and in the seventh example, the CPU 12 refers to character data (for example, see FIG. 25A) of the document contents to produce a partial image 1 (an image made in a manner that characters exceeding the font size F1 are extracted and located at a predetermined position) for the page display according to the display method 1 and a partial image 2 (an image made in a manner that an image is extracted and located at a predetermined position) for the page display according to the display method 2 for each page, and puts them in the memory 13 (step S134).

Following this, the processing (steps S14 and S21 to S28) similar to the first display processing example shown in FIG. 3 takes place.

In the seventh example, however, when the automatic paging 1 is selected in the step S21 (“automatic paging 1” route from step S21), the partial image 1 produced in the step S134 is displayed as the display according to the display method 1 in the step S23, thus displaying the characters exceeding the font size F1 at every page.

When the automatic paging 2 is selected in the step S21 (“automatic paging 2” route from step S21), the partial image 2 produced in the step S134 is displayed as the display according to the display method 2 in the step S26, thus displaying an image on that page.

In this way, in the seventh display processing example, a partial image comprising characters exceeding the font size F1 is displayed in the first automatic paging display mode while a partial image comprising only an image is displayed in the second automatic paging display mode, thereby automatically conducting the paging at an established speed while partially displaying the contents of each page.

(3-8) Description of Eight Example of Display Processing

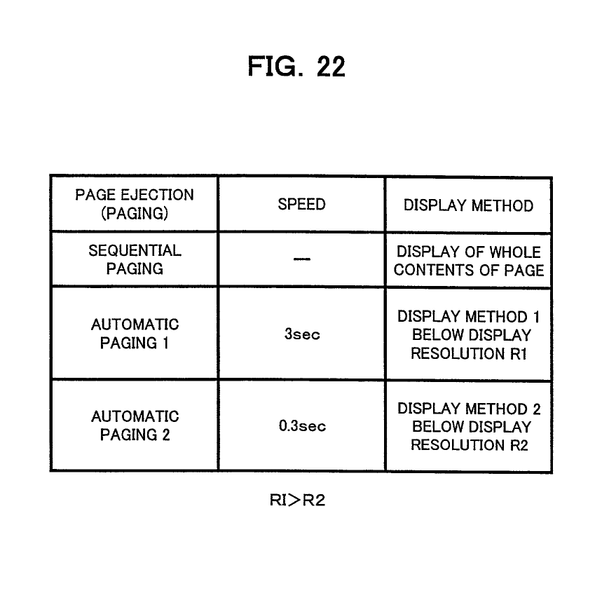

An eighth example of display processing in the display apparatus 10 according to this embodiment will be described hereinbelow with reference to FIG. 22 and a flow chart (steps S11 to S14 and S21 to S28). FIG. 22 is an illustration of establishment contents (establishment table) in display modes in the eighth display processing example.

Also in the eighth display processing example, as with the first example, when the display apparatus 10 is put in operation, through the use of the input unit 14, a reader sets a paging speed in each automatic paging display mode (step S11) and sets a display method in each automatic paging display mode (each speed) (step S12).

An establishment example of the eight example is shown in FIG. 22. In the establishment table shown in FIG. 22, the paging speed for the automatic paging 1 is set at three seconds, the paging speed for the automatic paging 2 is set at 0.3 second, and the whole contents of each page are displayed in the case of the sequential paging, while in the case of the automatic paging 1 and the automatic paging 2, the page displays are made at display resolutions R1 and R2 (R1>R2) according to the display method 1 and the display method 2.

After the establishment made in this way, the processing (steps S13, S14 and S21 to S28) similar to the first display processing example shown in FIG. 3 takes place.

In the eighth example, however, when the automatic paging 1 is selected in the step S21 (“automatic paging 1” route from step S21), in the step S23 each page is converted into an image with the display resolution R1 according to the display method 1 set in the step S12 and schematically displayed. In like manner, when the automatic paging 2 is selected in the step S21 (“automatic paging 2” route from step S21), in the step S26 each page is converted into an image with the display resolution R2 according to the display method 2 set in the step S12 and schematically displayed.

At this time, assuming that the display resolution R1 is taken to be 25% of the resolution of the original, averaging processing is conducted on the pixels of an image so that four pixels are handled as one pixel and the average value of the pixel values of the four pixels is taken as the pixel value of the one pixel. With this averaging processing, an image with the display resolution R1 corresponding to the original image degraded is obtainable. The display resolution R2 set for the automatic paging 2 higher in paging speed than the automatic paging 1 is set to be lower than the display resolution R1; therefore, the page display state in the case of the automatic paging 2 is further degraded (rough state) as compared with the page display state resulting from the automatic paging 1.

In this way, in the eighth display processing example, in each automatic paging display mode, the display resolution of each page is changed in accordance with the paging speed so that the display resolution is lower as the paging speed increases, thus automatically conducting the paging at an established speed while schematically displaying the contents of each page. Accordingly, only the document configuration on each page is schematically displayed at the paging.

Incidentally, in the above-described eighth example, although each page is converted into an image with a predetermined display resolution in the step S23 or S26, it is also possible that, at the time that the document contents are read in the step S13, the images with the respective display resolutions are produced in advance and stored in the memory 13.

(3-9) Description of Display Mode Establishing Methods

FIG. 23A is an illustration of an individual establishment example (establishment table) in display modes, using the input unit (establishing means) 14 in the display apparatus 10 according to this embodiment, and FIG. 23B is an illustration of display methods establishable through the use of the input unit (establishing means) 14 in this embodiment.

In the display apparatus 10 according to this embodiment, as mentioned above, the input unit 14 is made to be capable of individually and arbitrarily setting a paging speed, a display method and others in each of automatic paging display modes.

Among the display methods establishable, for example, as shown in FIG. 23B, there are partial display based on a font type or font size, image display, schematic display based on the resolution conversion, layout display and others. In addition, arbitrary combinations of these display methods are also acceptable.

For example, in the establishment table as shown in FIG. 23A, the paging speed for the automatic paging 1 is set at three seconds, the paging speed for the automatic paging 2 is set at 0.3 second, and the whole contents of each page are displayed in the case of the sequential paging, while in the case of the automatic paging 1, the page display is made at a display resolution below the value R1 according to the display method 1, and in the case of the automatic paging 2, the page display is made with extracted characters of the font type 2 according to the display method 2.

Thus, since the display methods for the automatic paging 1 and the automatic paging 2 are set individually (independently), when the automatic paging 1 is selected, each page is converted into an image with the display resolution R1 to be schematically displayed according to the display method 1, and upon the selection of the automatic paging 2, the characters of the font type 2 are extracted and placed at a predetermined position to be displayed as a partial image according to the display method 2. (4) Description of Effects of the Embodiment

As described above, in the display apparatus (electronic document contents display) 10 according to this embodiment, when a reader carefully reads a predetermined page, the reading display mode (sequential paging) is selected so that the whole contents of that page are fixedly displayed on the display panel 11. When conducting the paging while seizing the contents of each page, the reader selects the automatic paging display mode (automatic paging 1 or automatic paging 2) in which the paging is conducted at a desired speed, in which case, pages are successively displayed partially or schematically on the display panel 11 at a desired speed and according to a display method meeting that speed.

In consequence, it is possible to shorten the waiting time for display switching between pages, attendant upon the paging, and to conduct the paging display while instantaneously providing information, useful for making a decision on whether or not that page includes a reading place, through the display panel 11 to the reader, without producing an additional waiting time.

In addition, through the use of the input unit 14, the reader can not only select/change the paging speed but also display each page according to a display method meeting the selected paging speed, and hence, the paging can be performed in a state where the contents of each page is seizable surely, and the paging for turning the pages and the paging for searching a reading place while confirming the contents are compatible with each other.

At this time, in the cursory reading display mode (automatic paging 1) forming one of the automatic paging display modes, for example, only a title of each page is displayed so that the reader can do the cursory reading for understanding the outline of the contents of each page.

On the other hand, in the case of the general view display mode (automatic paging 2), the paging is conducted at a speed higher than that of the automatic paging 1 and an in-page layout (see the layout display on the right side of FIG. 14) is illustratively displayed at every page so that the reader can generally view the whole of each page.

That is, by using the display apparatus 10 according to this embodiment, a reader can make three kinds of page display [careful reading, cursory reading (skimming), general view (glancing)] to the reading/searching behaviors to be done when human beings read documents such as magazines and newspapers actually.

Accordingly, the display apparatus 10 according to an embodiment of the present invention can offer the following effects.

(i) A reader can conduct the paging while making the display of each page on the display panel 11 in a state where the contents of each page are understandable surely to the reader, which surely prevents passing by a desired page and shortens the waiting time for display switching between pages so that the reader can promptly, easily and surely find a desired page.

(ii) The page display to the reading/searching behaviors to be done when human beings read documents actually can be made on the display panel 11, thus realizing a display apparatus (electronic document contents display) 10 having a high-operability page turning function providing a sensation closer to the real books.

(iii) In the automatic paging display modes (automatic paging 1 and automatic paging 2), some are extracted from document elements constituting each page under a condition (for example, font size or font type) established in advance, and displayed to accomplish partial display of each page; therefore, the paging can be conducted in a state where only the title portion of the document contents or the emphasized portion appears on the display panel 11.

(iv) In the automatic paging display modes (automatic paging 1 and automatic paging 2), only an image at each page is extracted and displayed to accomplish partial display of each page; therefore, only the image portion instantaneously and easily seizable at the paging can be put on the display panel 11.

(v) In the automatic paging display modes (automatic paging 1 and automatic paging 2), the display resolution of each page can be changed in accordance with the paging speed (the display resolution is changed to become lower as the speed increases); therefore, the contents of each page can be schematically displayed and only the document configuration of each page can be put on the display panel 11 at the paging.

(vi) Since the display method and paging speed can be set in each automatic paging display mode through the use of the input unit 14, it is possible to cope with various kinds of document contents, and a reader who uses the display apparatus (electronic document contents display) can arbitrarily set a display method and a speed in conducting the paging.

(vii) As described above with reference to FIGS. 5 and 6A, the automatic paging display mode is determined on the basis of the paging switch pressing time t, which permits the automatic paging display mode to be switched automatically.

(viii) The automatic paging display mode is determined in accordance with a manipulation way of a plurality of paging switches (for example, see numerals 141a to 143a and 141b to 143b in FIGS. 7 and 10), with the result that the automatic paging display mode can arbitrarily be switched according to the intention of a reader.

(5) Others

It should be understood that the present invention is not limited to the above-described embodiment, and that it is intended to cover all changes and modifications of the embodiments of the invention herein which do not constitute departures from the spirit and scope of the invention.

For example, in the above description of this embodiment, although the present invention has been applied to a portable display (PDA) shown in FIG. 24A, the present invention is not limited to this, but as with the above-stated embodiment, the invention is also applicable to information equipment (for example, a notebook size PC, a desktop PC shown in FIG. 24B, or the like), and even in this case, the effects similar those of the above-stated embodiment are attainable.

Moreover, in the above description of this embodiment, although two kinds of display modes: cursory reading display mode and general view display mode, have been described as the automatic paging display modes, the present invention is not limited to this, but it is also possible to set three or more kinds of automatic paging display modes.

What is claimed is:

1. A display apparatus comprising:
a displaying section for displaying document contents made up in units of page;
a displaying control section for controlling a display state of said displaying section;
means for providing a reading display mode of displaying the whole contents of each page of said document contents on said displaying section;
means for providing a plurality of automatic paging display modes of conducting page ejection (paging) at different speeds and successively displaying partially or schematically the contents of each page of said document contents on said displaying section according to a display method corresponding to each of said different speeds; and
selecting means for selecting one of said reading display mode and said plurality of automatic paging display modes,
said display control section controlling the display state of said displaying section to display said document contents on said displaying section in the display mode selected by said selecting means.

2. A display apparatus according to claim 1, wherein said plurality of automatic paging display modes includes at least two modes of a cursory reading display mode of making display so that the outline of the contents of each page is seizable to a reader and a general view display mode of conducting page ejection (paging) at a speed higher than that of said cursory reading display mode to make display so that the whole of each page is generally viewable to said reader.

3. A display apparatus according to claim 2, wherein, in said cursory reading display mode, only a title of each page is extracted and displayed to provide title-display, while in said general view display mode, a layout of each page is illustratively displayed to provide layout-display.

4. A display apparatus according to claim 1, wherein, in at least one of said plurality of automatic paging display modes, said display method makes said displaying section display partially each page by extracting a document element corresponding to a predetermined condition from document elements constituting each page and displaying said extracted document element on said displaying section.

5. A display apparatus according to claim 4, wherein said condition involves a font size.

6. A display apparatus according to claim 4, wherein said condition involves a font type.

7. A display apparatus according to claim 1, wherein, in at least one of said plurality of automatic paging display modes, said display method makes said displaying section display partially each page by extracting only an image from each page and displaying said extracted image on said displaying section.

8. A display apparatus according to claim 1, wherein, in at least one of said plurality of automatic paging display modes, said display method makes said displaying section display schematically each page by changing a display resolution on each page in accordance with said speed.

9. A display apparatus according to claim 1, further comprising establishing means for individually establishing said display method in each of said plurality of automatic paging display modes.

10. A display apparatus according to claim 9, wherein said establishing means is additionally made to establish said speed in each of said plurality of automatic paging display modes.

11. A display apparatus according to claim 1, wherein said selecting means is equipped with a paging switch, and is made to determine said automatic paging display mode to be selected, on the basis of a manipulation time of said paging switch.

12. A display apparatus according to claim 1, wherein said selecting means is equipped with a plurality of paging switches, and is made to determine said automatic paging display mode to be selected, on the basis of a manipulation method of said plurality of paging switches.

13. A computer-readable recording medium in which a display control program is recorded, wherein, in order to display document contents, made up in units of page, on a displaying section, said display control program making a computer function as the following:
means for providing a reading display mode of displaying the whole contents of each page of said document contents on said displaying section;
means for providing a plurality of automatic paging display modes of conducting page ejection (paging) at different speeds and successively displaying partially or schematically the contents of each page of said document contents on said displaying section according to a display method corresponding to each of said different speeds; and
a display control section to control a display state of said displaying section for displaying said document contents on said displaying section in a display mode selected from said reading display mode and said plurality of automatic paging display modes.

14. A computer-readable recording medium according to claim 13, wherein said plurality of automatic paging display modes includes at least two modes of a cursory reading display mode of making display so that the outline of the contents of each page is seizable to a reader and a general view display mode of conducting page ejection (paging) at a speed higher than that of said cursory reading display mode to make display so that the whole of each page is generally viewable to said reader.

15. A computer-readable recording medium according to claim 14, wherein, in said cursory reading display mode, only a title of each page is extracted and displayed to provide title-display, while in said general view display mode, a layout of each page is illustratively displayed to provide layout-display.

16. A computer-readable recording medium according to claim 13, wherein, in at least one of said plurality of automatic paging display modes, said display method makes said displaying section display partially each page by extracting a document element corresponding to a predetermined condition from document elements constituting each page and displaying said extracted document element on said displaying section.

17. A computer-readable recording medium according to claim 16, wherein said condition involves a font size.

18. A computer-readable recording medium according to claim 16, wherein said condition involves a font type.

19. A computer-readable recording medium according to claim 13, wherein, in at least one of said plurality of automatic paging display modes, said display method makes said displaying section display partially each page by extracting only an image from each page and displaying said extracted image on said displaying section.

20. A computer-readable recording medium according to claim 13, wherein, in at least one of said plurality of automatic paging display modes, said display method makes said displaying section display schematically each page by changing a display resolution on each page in accordance with said speed.
